(19) United States
(12) Patent Application Publication
(10) Pub. No.: US 2013/0059592 A1
(43) Pub. Date: Mar. 7, 2013

(54) FEMTOCELL TIMING SYNCHRONIZATION USING MOBILE DEVICE MESSAGING

(71) Applicants: Kaushik Chakraborty, San Diego, CA (US); Soumya Das, San Diego, CA (US); Samir S. Soliman, San Diego, CA (US)

(72) Inventors: Kaushik Chakraborty, San Diego, CA (US); Soumya Das, San Diego, CA (US); Samir S. Soliman, San Diego, CA (US)

(73) Assignee: QUALCOMM Incorporated, San Diego, CA (US)

(21) Appl. No.: 13/224,092

(22) Filed: Sep. 1, 2011

(51) Int. Cl. H04W 36/00

(52) U.S. Cl. 455/444

(57) ABSTRACT

Methods, systems, and devices are described for femtocells to retrieve neighboring macrocells' timing information, using messages from mobile devices that are associated with the relevant macrocell In some cases, detection of the femtocell, such as through an out-of-band detection, may trigger the mobile device to determine timing information with respect to the macrocell and/or the femtocell. In some embodiments, the mobile device associated with the macrocell may be in active state and looking for a candidate femtocell for handover. The femtocell may receive this timing information from the mobile device and utilize it to synchronize with the neighboring macrocell. Embodiments may address fine timing synchronization and tracking for asynchronous and quasi-synchronous wide-area wireless networks (e.g., 3GPP/3GPP2 variants like UMTS, LTE, CDMA 1x, 1x EV-DO, etc).

### CROSS REFERENCES

The present application for patent is related to the following co-pending U.S. patent application Ser. No. 12/703,065, entitled “METHOD AND APPARATUS FOR FACILITATING A HAND-IN OF USER EQUIPMENT TO FEMTO CELLS,” and referenced as IDF No. 090935, U.S. patent application Ser. No. 12/947,022, entitled “ACCESS TERMINAL-ASSISTED TIME AND/OR FREQUENCY TRACKING,” and referenced as IDF 100107U1, and U.S. patent application Ser. No. 12/947,039, entitled “IDLE ACCESS TERMINAL-ASSISTED TIME AND/OR FREQUENCY TRACKING,” and referenced as IDF 100107U2, each assigned to the assignee hereof and hereby expressly incorporated by reference herein.

### BACKGROUND

Communication networks are in wide use today, and often have multiple devices in communication over wireless links to carry voice and data. Many of these devices, such as cellular phones, smartphones, laptops, and tablets, are mobile, and may connect with a network wirelessly via a base station, access point, wireless router, or Node B (collectively referred to herein as “access points”). A mobile device may remain within the service area of such an access point for a relatively long period of time (thereby being “camped on” the access point) or may travel relatively rapidly through access point service areas, with cellular handover or reselection techniques being used for maintaining a communication session, or for idle mode operation as association with access points is changed.

Issues with respect to available spectrum, bandwidth, or capacity may result in access being unavailable or inadequate between certain mobile devices and an access point. Likewise, issues with respect to wireless signal propagation (e.g., shadowing, multipath fading, interference, etc.) may result in access being unavailable for particular mobile devices.

Cellular networks have employed the use of various cell types, such as macrocells, microcells, picocells, and femtocells, to provide desired bandwidth, capacity, and wireless communication coverage within service areas. Femtocells may be used to provide wireless communication in areas of poor network coverage (e.g., inside of buildings), to provide increased network capacity, and to utilize broadband network capacity for backhaul. There are a number of challenges to accomplish a macrocell to femtocell hand-in.

### SUMMARY

Embodiments include methods, systems, and devices for femtocells to synchronize with a neighboring macrocell using timing offsets sent from a mobile device that is associated with the neighboring macrocell. In some cases, detection of the femtocell, such as through an out-of-band detection, may trigger the mobile device to determine timing information with respect to the macrocell and/or the femtocell. In some embodiments, the mobile device associated with the macrocell may be in active state and looking for a candidate femtocell for handover. Embodiments may address timing synchronization and tracking for asynchronous and quasi-synchronous wireless networks (e.g., 3GPP/3GPP2 variants like UMTS, LTE, CDMA 1x, 1x EV-DO, etc).

In some embodiments, the mobile device may detect the femtocell in its proximity while the mobile device is camped out on the macrocell. The mobile device may detect the femtocell using the femtocell's primary scrambling code (PSC) signal, for example. Detecting the femtocell in its proximity may trigger the mobile device to determine timing offsets that may aid the femtocell in synchronizing with the macrocell. The mobile device may receive timing information from the femtocell and the macrocell. The mobile device may then determine a timing offset between the mobile device and the macrocell. The mobile device may also determine a timing offset between the mobile device and the femtocell. The timing offsets may be represented as differences between frame counters in some situations. In some embodiments, the timing offset could include, but is not limited to, a ΔOTD (offset of observable time difference) between the macrocell and femtocell, offsets between pilots or known reference signals (e.g., PN offsets between the macrocell and femtocell), or an offset with respect to macro-assisted GPS timing information. A timing offset between the macrocell and the femtocell may be determined using the two other timing offsets relative to the mobile device. The mobile device may transmit one or more of these timing offsets to the femtocell, either directly or indirectly. The timing offset between the macrocell and the femtocell may be utilized to achieve timing synchronization and tracking at the femtocell.

In some embodiments, the mobile device may determine the timing offset between the macrocell and the femtocell. The mobile device may then transmit this timing offset between the macrocell and the femtocell directly to the femtocell, such as through an out-of-band (OOB) link (e.g., WiFi or Bluetooth link). In some situations, the mobile device may transmit this timing offset between the macrocell and the femtocell directly to the femtocell over a WAN link between the mobile device and the femtocell when the mobile device has been handed over from the macrocell to the femtocell. An IP tunnel between the mobile device and the femtocell (e.g., remote IP access or RIPA) may also be utilized in some embodiments. The mobile device may more generally send this timing offset to the femtocell through the macrocell to a femtocell gateway. For example, the mobile device may send the timing offset indirectly to the femtocell through a WAN link between the macrocell and the macrocell. The femtocell gateway may then forward the timing offset to the femtocell.

In some embodiments, other devices such as the femtocell gateway or the femtocell itself may determine the timing offset between the macrocell and the femtocell. In these cases, the mobile device may transmit both the timing offset between the mobile device and the macrocell and the timing offset between the mobile device and the femtocell to the other device. This other device may then utilize these two timing offsets with respect to the mobile device to determine the timing offset between the macrocell and the femtocell. The timing offset between the mobile device and the macrocell and the timing offset between the mobile device and the femtocell may be sent from the mobile device as part of a message that may be referred to as a measurement report message.

Once the femtocell has the timing offset between the macrocell and itself, it can make appropriate corrections in its timing and thus synchronize with its neighboring macrocell.

In some cases, the measured timing offset may be used for timing correction at the femtocell where the actual timing offset between the femtocell and macrocell may be below a maximum threshold. For example, a frame number difference may be correctly measuring the timing offset where the offset may be less than a frame duration (e.g. 10 ms in UMTS). If the actual timing offset may be greater than 10 ms, then there may be an ambiguity in terms of the frame count. Some embodiments may thus target time tracking and/or fine synchronization. Some embodiments may focus on situations where a femtocell and a macrocell may be synchronized within a frame duration. In some embodiments, there may be an initial coarse synchronization step that may achieve synchronization between the reference timing and femtocell timing within the respective acceptable thresholds for the different offsets that may be utilized.

Some embodiments include a method of providing synchronization information. The method may include receiving, at a mobile device associated with a macrocell, a first timing information from the macrocell. A second timing information from a femtocell may be received at the mobile device. One or more timing offsets may be determined at the mobile device utilizing at least the first timing information regarding the macrocell or the second timing information regarding the femtocell. The one or more timing offsets may be transmitted from the mobile device to the femtocell.

The method of providing synchronization information may further include detecting, at the mobile device, the femtocell in proximity to the mobile device. Detecting the femtocell in proximity to the mobile device may include detecting, at the mobile device, a primary scrambling code (PSC) signal of the femtocell. Detecting the femtocell in proximity to the mobile device may include detecting, at the mobile device, an out-of-band (OOB) signal of the femtocell. Detecting the femtocell in proximity to the mobile device may trigger the mobile device to determine the one or more timing offsets at the mobile device and to transmit the one or more timing offsets from the mobile device to the femtocell.

Determining the one or more timing offsets may include determining a difference between the first timing information from the macrocell and the second timing information from the femtocell. Determining the difference between the first timing information from the macrocell and the second timing information from the femtocell may include determining a frame number difference between the macrocell and the femtocell. Transmitting the one or more timing offsets from the mobile device to the femtocell may include transmitting the frame number difference between the macrocell and the femtocell to the femtocell. Determining the difference between the first timing information from the macrocell and the second timing information from the femtocell may include determining at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell. Transmitting the one or more timing offsets from the mobile device to the femtocell may include transmitting at least the timing difference between the macro-assisted GPS timing and the femtocell timing, the ΔOTD timing difference between the macrocell and the femtocell, the pilot burst timing difference between the macrocell and the femtocell, or the known reference signal timing difference between the macrocell and the femtocell to the femtocell.

Transmitting the one or more timing offsets from the mobile device to the femtocell may include transmitting the one or more timing offsets from the mobile device to the femtocell over an out-of-band (OOB) link. Transmitting the one or more timing offsets from the mobile device to the femtocell may include transmitting a first frame number difference between the macrocell and the mobile device and a second frame number difference between the femtocell and the mobile device to the femtocell. Transmitting the one or more timing offsets from the mobile device to the femtocell may include transmitting at least a macro-assisted GPS timing and a femtocell timing, a first ΔOTD timing difference between the macrocell and the mobile device and a second ΔOTD timing difference between the femtocell and the mobile device, a first pilot burst timing difference between the macrocell and the mobile device and a second pilot burst timing difference between the femtocell and the mobile device, or a first known reference signal timing difference between the macrocell and the mobile device and a second known reference signal timing difference between the femtocell and the mobile device. Transmitting the one or more timing offsets from the mobile device to the femtocell may include transmitting the one or more timing offsets from the mobile device to the femtocell over an in-band link.

In some embodiments, transmitting the one or more timing offsets from the mobile device to the femtocell may include transmitting the one or more timing offsets from the mobile device through the macrocell to the femtocell. Transmitting the one or more timing offsets from the mobile device through the macrocell to the femtocell may include transmitting the one or more timing offsets from the mobile device to the femtocell through an IP tunnel. Transmitting the one or more timing offsets from the mobile device through the macrocell to the femtocell may include transmitting the one or more timing offsets from the mobile device to the femtocell through a core network. In some embodiments, at least one of the macrocell, the core network, a femtocell gateway, or the femtocell may determine for the femtocell a difference between the first timing information from the macrocell and the second timing information from the femtocell. In some embodiments, the one or more timing offsets may be transmitted from the mobile device to the femtocell as part of a measurement report message.

In some embodiments, the first time information from the macrocell may include a system frame number of the macrocell and the second time information from the femtocell may include a system frame number of the femtocell. In some embodiments, the first time information from the macrocell may include at least a ΔOTD timing from the macrocell, a pilot burst timing from the macrocell, or a known reference signal timing from the macrocell and the second time information from the femtocell comprises at least at least a ΔOTD timing from the femtocell, a pilot burst timing from the femtocell, or a known reference signal timing from the femtocell.

Some embodiments include a system for providing synchronization information. The system may include a means for receiving, at a mobile device associated with a macrocell, a first timing information from the macrocell; a means for receiving at the mobile device a second timing information from a femtocell; a means for determining one or more timing offsets at the mobile device utilizing at least the first timing information regarding the macrocell or the second timing information regarding the femtocell; and/or a means for transmitting the one or more timing offsets from the mobile device to the femtocell.

The system for providing synchronization information may further include a means for detecting, at the mobile device, the femtocell in proximity to the mobile device. The system for providing synchronization information may further include a means for transmitting the one or more timing offsets from the mobile device to the femtocell over an out-of-band (OOB) link.

Some embodiments may include a mobile device configured to provide synchronization information. The mobile device may include a receiver configured to receive at least a first timing information from a macrocell associated with the mobile device or a second timing information from a femtocell. The mobile device may include a timing offset module configured to determine one or more timing offsets utilizing at least the first timing information from the macrocell or the second timing information from the femtocell. The mobile device may include a transmitter configured to transmit the one or more timing offsets to the femtocell.

The receiver may be further configured to detect the femtocell in proximity to the mobile device. The transmitter may be further configured to transmit the one or more timing offsets from the mobile device to the femtocell over an out-of-band (OOB) link. The transmitter may be further configured to transmit the one or more timing offsets from the mobile device through the macrocell to the femtocell. The timing offset module may be further configured to determine a frame number difference between the macrocell and the femtocell. The timing offset module may be further configured to determine at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

Some embodiments include a computer program product for providing synchronization information including a computer-readable medium that may include: code for receiving, at a mobile device associated with a macrocell, a first timing information from the macrocell; code for receiving at the mobile device a second timing information from a femtocell; code for determining one or more timing offsets at the mobile device utilizing at least the first timing information regarding the macrocell or the second timing information regarding the femtocell; and/or code for transmitting the one or more timing offsets from the mobile device to the femtocell.

Some embodiments include a method of synchronizing a femtocell with a macrocell The method may include receiving, at the femtocell, one or more timing offsets transmitted from the mobile device associated with the macrocell. At least one of the one or more timing offsets may include timing information with respect to the macrocell. The femtocell may be synchronized with the macrocell utilizing the one or more timing offsets.

In some embodiments, the method of synchronizing the femtocell with the macrocell may further include determining, at the femtocell, a difference between a first timing information of the macrocell and a second timing information of the femtocell utilizing the one or more received timing offsets. The determined difference between the first time information of the macrocell and the second time of the femtocell may include a frame number difference between a system frame number of the macrocell and a system frame number of the femtocell. The determined difference between the first time information of the macrocell and the second time of the femtocell may include at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

Receiving, at the femtocell, the one or more timing offsets transmitted from the mobile device may include receiving the one or more timing offsets from the mobile device over an out-of-band (OOB) link between the mobile device and the femtocell. Receiving, at the femtocell, the one or more timing offsets transmitted from the mobile device may include receiving the one or more timing offsets from the mobile device over an in-band link between the mobile device and the femtocell. The one or more timing offsets may be received from the mobile device as part of a measurement report message

Receiving, at the femtocell, the one or more timing offsets transmitted from the mobile device may include receiving the one or more timing offsets from the mobile device through the macrocell. Receiving, at the femtocell, the one or more timing offsets transmitted from the mobile device through the macrocell may include receiving the one or more timing offsets from the mobile device through an IP tunnel between the mobile device and the femtocell. Receiving, at the femtocell, the one or more timing offsets transmitted from the mobile device through the macrocell may include receiving the one or more timing offsets from the mobile device through a core network.

Receiving, at the femtocell, the one or more timing offsets transmitted from the mobile device may include receiving a difference between a first timing information of the macrocell and the second timing information of the femtocell. The received difference between the first timing information of the macrocell and the second time of the femtocell may include a frame number difference between the macrocell and the femtocell. The received difference between the first timing information of the macrocell and the second time of the femtocell may include at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

Some embodiments include a system for synchronizing a femtocell with respect to a macrocell utilizing a mobile device. The system may include: a means for receiving, at the femtocell, one or more timing offsets transmitted from the mobile device associated with the macrocell, wherein at least one of the one or more timing offsets includes timing information with respect to the macrocell; and/or a means for synchronizing the femtocell with the macrocell utilizing the one or more timing offsets.

The system for synchronizing a femtocell with respect to a macrocell may further include a means for determining, at the femtocell, a difference between a first timing information of the macrocell and a second timing information of the femtocell utilizing the one or more received timing offsets. The system for synchronizing a femtocell with respect to a macrocell may further inca means for receiving the one or more timing offsets from the mobile device over an out-of-band (OOB) link between the mobile device and the femtocell.

Some embodiments include femtocell configured to synchronize with respect to a macrocell utilizing a mobile device. The femtocell may include a receiver configured to receive one or more timing offsets transmitted from the mobile device associated with the macrocell. At least one of the one or more timing offsets may include timing information with respect to the macrocell. The femtocell may include a synchronization module configured to synchronizing the femtocell with the macrocell utilizing the one or more timing offsets.

The femtocell may further include a timing offset module configured to determine a difference between a first timing information of the macrocell and a second timing information of the femtocell utilizing the one or more received timing offsets. In some embodiments, the receiver module may be further configured to receive the one or more timing offsets from the mobile device over an out-of-band (OOB) link between the mobile device and the femtocell.

Some embodiments include a computer program product for synchronizing a femtocell with respect to a macrocell utilizing a mobile device. The computer program product includes a computer-readable medium that may include: code for receiving, at the femtocell, one or more timing offsets transmitted from the mobile device associated with the macrocell, wherein at least one of the one or more timing offsets includes timing information with respect to the macrocell; and/or code for synchronizing the femtocell with the macrocell utilizing the one or more timing offsets.

The foregoing has outlined rather broadly examples according to disclosure in order that the detailed description that follows may be better understood. Additional features will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2 shows a network diagram of a wireless communications system for providing synchronization information from a macrocell to a femtocell utilizing a mobile device in accordance with various embodiments;

FIG. 3A shows a communications diagram of a wireless communications system with a mobile device, a macrocell, and a femtocell, in accordance with various embodiments;

FIG. 3B shows a communications diagram of a wireless communications system with a mobile device, a macrocell, and a femtocell, in accordance with various embodiments;

FIG. 4A shows a block diagram of an example of a device with timing offset functionality in accordance with various embodiments;

FIG. 4B shows a block diagram of an example of a mobile device with timing offset functionality in accordance with various embodiments;

FIG. 5A shows a block diagram of an example of a device with timing offset and synchronization functionality in accordance with various embodiments;

FIG. 5B shows a block diagram of an example of a femtocell with timing offset and synchronization functionality in accordance with various embodiments;

FIG. 6A shows a flow diagram of a method for providing synchronization information regarding a macrocell to a femtocell utilizing a mobile device in accordance with various embodiments;

FIG. 6B shows a flow diagram of a method for providing synchronization information regarding a macrocell to a femtocell utilizing a mobile device in accordance with various embodiments;

FIG. 6C shows a flow diagram of a method for providing synchronization information regarding a macrocell to a femtocell utilizing a mobile device in accordance with various embodiments;

FIG. 6D shows a flow diagram of a method for providing synchronization information regarding a macrocell to a femtocell utilizing a mobile device in accordance with various embodiments;

FIG. 6E shows a flow diagram of a method for providing synchronization information regarding a macrocell to a femtocell utilizing a mobile device in accordance with various embodiments;

FIG. 6F shows a flow diagram of a method for providing synchronization information regarding a macrocell to a femtocell utilizing a mobile device in accordance with various embodiments;

FIG. 7A shows a flow diagram of a method for providing synchronization information regarding a macrocell to a femtocell utilizing a mobile device in accordance with various embodiments; and

FIG. 7B shows a flow diagram of a method for providing synchronization information regarding a macrocell to a femtocell utilizing a mobile device in accordance with various embodiments.

### DETAILED DESCRIPTION

Embodiments include methods, systems, and devices for femtocells to synchronize with a neighboring macrocell using timing offsets sent from a mobile device that is associated with the neighboring macrocell. In some cases, detection of the femtocell, such as through an out-of-band detection, may trigger the mobile device to determine timing information with respect to the macrocell and/or the femtocell. In some embodiments, the mobile device associated with the macrocell may be in active state and looking for a candidate femtocell for handover. The femtocell may receive one or more timing offsets from the mobile device. The femtocell may then utilize the one or more timing offsets to synchronize with the neighboring macrocell. Embodiments may address timing synchronization and tracking for asynchronous and quasi-synchronous wireless networks (e.g., 3GPP/3GPP2 variants like UMTS, LTE, CDMA 1x, 1x EV-DO, etc).

In some embodiments, the mobile device may detect the femtocell in its proximity while the mobile device is camped out on a macrocell. The mobile device may detect the femtocell using the femtocell's primary scrambling code (PSC) signal. Detecting the femtocell in its proximity may trigger the mobile device to determine timing offsets that may aid the femtocell in synchronizing with the macrocell. The mobile device may receive timing information from the femtocell and the macrocell. The mobile device may then determine a timing offset between the mobile device and the macrocell, along with a timing offset between the mobile device and the femtocell. The timing offsets may be represented as differences between frame counters in some situations. In some embodiments, the timing offset could include, but is not limited to, a ΔOTD (offset of observable time difference) between the macrocell and femtocell, offsets between pilots or known reference signals (e.g., PN offsets between the marcrocell and femtocell), or an offset with respect to macro-assisted GPS timing information. A timing offset between the macrocell and the femtocell may then be determined using the two other timing offsets. The mobile device may transmit one or more of these timing offsets to the femtocell, either directly or indirectly. The timing offset between the macrocell and the femtocell may be utilized to achieve timing synchronization and tracking at the femtocell.

In some embodiments, the mobile device may determine the timing offset between the macrocell and the femtocell. The mobile device may then transmit this timing offset between the macrocell and the femtocell directly to the femtocell, such as through a WAN link or an out-of-band (OOB) link (e.g., WiFi or bluetooth link). An IP tunnel between the mobile device and the femtocell (e.g., remote IP access or RIPA) may also be utilized in some embodiments. The mobile device may more generally send this timing offset to the femtocell through the macrocell to a femtocell gateway. The femtocell gateway may then forward the timing offset to the femtocell.

In some embodiments, other devices such as the femtocell gateway or the femtocell itself may determine the timing offset between the macrocell and the femtocell. In these cases, the mobile device may transmit both the timing offset between the mobile device and the macrocell and the timing offset between the mobile device and the femtocell to the other device. This other device may then utilize these two timing offsets with respect to the mobile device to determine the timing offset between the macrocell and the femtocell. The timing offset between the mobile device and the macrocell and the timing offset between the mobile device and the femtocell may be sent from the mobile device as part of a message that may be referred to as a measurement report message.

Once the femtocell has the timing offset between the macrocell and itself, it can make appropriate corrections in its timing and thus synchronize with its neighboring macrocell.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

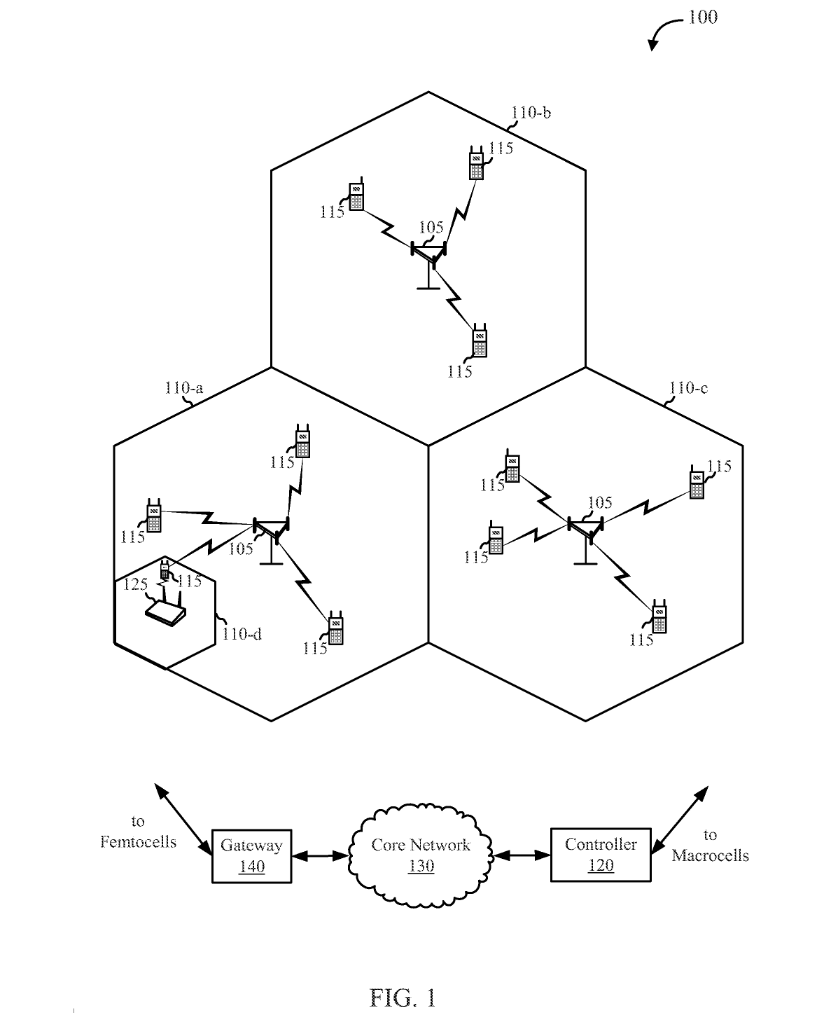

Referring first to FIG. 1, a block diagram illustrates an example of a wireless communications system 100 in accordance with various embodiments. The system 100 may include macrocell base stations 105, mobile devices 115, a base station controller 120, a femtocell 125, and/or a core network 130 (the controller 120 may be integrated into the core network 130). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The mobile devices 115 may be any type of mobile station, mobile device, access terminal, subscriber unit, or user equipment. The mobile devices 115 may include cellular phones and wireless communications devices, but may also include personal digital assistants (PDAs), smartphones, other handheld devices, netbooks, notebook computers, etc. Thus, the term user mobile device should be interpreted broadly hereinafter, including the claims, to include any type of wireless or mobile communications device.

The macrocell base stations 105 may wirelessly communicate with the mobile devices 115 via one or more base station antennas. The mobile device 115 may receive timing information from the macrocell base station 105 in accordance with various embodiments. The macrocell base stations 105 may be configured to communicate with the mobile devices 115 under the control of the controller 120 via multiple carriers. The controller 120 may also be in communication with the core network 130. Each of the base station 105 sites can provide communication coverage for a respective geographic area. In some embodiments, macrocell base stations 105 may be referred to as a Node B. The coverage area for each macrocell base station 105 here is identified as 110-a, 110-b, or 110-c. The coverage area for a base station may be divided into sectors (not shown, but making up only a portion of the coverage area). The system 100 may include base stations 105 of different types (e.g., macro, micro, and/or pico base stations). As used herein, the term “cell” may refer to 1) a sector, or 2) a site (e.g., a base station 105). Thus, the term “macrocell” may refer to 1) a macrocell sector, 2) a macrocell base station (e.g., macrocell base station 105), and/or 3) a macrocell controller. Thus, the term “femtocell” may refer to 1) a femtocell sector, or 2) a femtocell base station (e.g., femtocell access point).

For the discussion below, the mobile devices 115 operate on (are “camped on”) a macro or similar network facilitated by multiple macrocell base stations 105. In some embodiments, a mobile device 115 may be referred to as being associated with a macrocell base station 105 when it is camped on the macrocell base station 105. Each macrocell base station 105 may cover a relatively large geographic area (e.g., hundreds of meters to several kilometers in radius) and may allow unrestricted access by terminals with service subscription. A portion of the mobile devices 115 may also be registered to operate (or otherwise allowed to operate) in femtocell coverage area 110-d (e.g., communicating with femtocell 125, which may be referred to as a femtocell access point (FAP) or a home node B (HNB) in some cases), within the coverage area of a macrocell 110-a. As a mobile device 115 approaches a femtocell 125, there may be need for mechanisms so that the mobile device 115 may migrate to the femtocell 125 from the macrocell base station 105. For example, the mobile device 115 may provide one or more timing offsets to the femtocell 125 such that the femtocell 125 may synchronize with the macrocell base station 105 that the mobile device 115 is currently camped on. This may facilitate a handin of the mobile device 115 from the macrocell base station 105 to the femtocell 125. The femtocells 125 may communicate with a gateway 140 that may aggregate traffic from multiple femtocells 125. The gateway 140 may then route the traffic of the femtocells 125 to the core network 130. The gateway 140 may be referred to as a femtocell gateway 140 in some cases. In some embodiments, the gateway 140 may include a Home Location Register (HLR). The gateway 140 may be considered as part of the core network 130 in some embodiments.

Strategic deployment of femtocells may be used to mitigate mobile device power consumption, as mobile devices typically operate using an internal power supply, such as a small battery, to facilitate highly mobile operation. Femtocells may be used to offload traffic and reduce spectrum usage at a macrocell. Femtocells may also be utilized to provide service within areas which might not otherwise experience adequate or even any service (e.g., due to capacity limitations, bandwidth limitations, signal fading, signal shadowing, etc.), thereby allowing mobile devices to reduce searching times, to reduce transmit power, to reduce transmit times, etc. A femtocell 125 may provide service within a relatively small service area (e.g., within a house or building). Accordingly, a mobile device 115 is typically disposed near a femtocell 125 when being served, often allowing the mobile device 115 to communicate with reduced transmission power.

In some cases, the femtocell 125 may be implemented as a Home Node B (“HNB”) or Home eNode B (HeNB), and located in a user premises, such as a residence, an office building, etc. Femtocell 125 may be used hereinafter generically to describe any femtocell access point, and should not be interpreted as limiting. A set of mobile devices 115 may be registered on (e.g., on a whitelist of) a single femtocell (e.g., femtocell 125) that provides coverage over substantially an entire user premises. The “home” femtocell 125 may provide the mobile device 115 with access to communication services via a connection to the macrocell communications network. As used herein, the macrocell communications network is assumed to be a wireless wide-area network (WWAN). As such, terms like “macrocell network” and “WWAN network” are interchangeable. Similar techniques may be applied to other types of network environments, femtocell coverage topologies, etc., without departing from the scope of the disclosure or claims.

Wireless communications system 100 may be utilized to provide methods, systems, and devices for femtocell 125 to retrieve a neighboring macrocell 105's timing information. This timing information, for example, may include a timing offset between the femtocell 125 and the macrocell 105. The mobile device 115 associated with the relevant macrocell 105 may be utilized to determine this timing offset in some cases. The mobile device 115 may also be looking for candidate femtocells 125 for active state handovers, from the macrocell 105 to the femtocell 125, for example. The femtocell 125 may receive timing offset information from the mobile device 115 and may utilize it to synchronize with the neighboring macrocell 105. Embodiments may address timing synchronization and tracking for asynchronous and quasi-synchronous wireless networks (e.g., 3GPP variants like UMTS, LTE, etc), for example.

In some embodiments, the mobile device 115 may detect the femtocell 125 in its proximity while the mobile device 115 is camped out on a macrocell 105. The mobile device 115 may detect the femtocell through detecting the femtocell 125's PSC signal. In some cases, the mobile device 115 may also detect the femtocell 125 in other ways, such as detecting out-of-band (OOB) signaling from the femtocell 125.

Having detected the femtocell 125, the mobile device 115 may receive timing information from the femtocell 125 and/or the macrocell 105. Detecting the femtocell 125 may also trigger the mobile device 115 to proceed with determining timing information with respect to the macrocell 105 and/or femtocell 125 that the mobile device 115 may then transmit to the femtocell 125 for synchronization purposes. In some cases, the mobile device 115 may already have received some timing information before detecting the femtocell 125 that it may utilize in some cases. For example, because the mobile device 115 may already be in communication with the macrocell 105, it may already have timing information from the macrocell 105 that it may utilize. The timing information that the mobile device 115 may utilize may include different types of timing information. For example, the mobile device 115 may utilize frame number information from the femtocell 125 and/or the mobile device 115. In some cases, the frame number information may include system frame number information. The mobile device 115 may also utilize its own frame number information. In some cases, the mobile device may also utilize connection frame number information. The mobile device 115 may receive and/or otherwise determine timing information from the femtocell 125 and/or macrocell 105 in other ways also.

Some embodiments may utilize other timing differences to determining timing offsets between the macrocell 105 and the femtocell 125. For example, some embodiments may utilize observable time differences (OTD). In this approach, a ΔOTD may be computed as (OTD_{femtocell}−OTD_{macrocell}). This difference may be matched with the ΔReference_OTD1(chip level), which may be the femtocell timing relative to macrocell. A measurement report message (MRM) from the UE 115 may contain the ΔOTD information in some cases.

Other timing difference information that may be utilized in some embodiments to determining timing offsets between the macrocell 105 and the femtocell 125 may include, but is not limited to, offsets between pilots or known reference signals (e.g., PN offsets between the macrocell 105 and the femtocell 105), or offsets with respect to macro-assisted GPS timing information.

Having received or otherwise determined timing information with respect to the macrocell 105 and/or femtocell 125, the mobile device 115 may determine a timing offset between the mobile device 115 and the macrocell 105, along with a timing offset between the mobile device 115 and the femtocell 125, in some cases. Timing offsets may be represented as differences between frame counters in some situations. A timing offset between the macrocell 105 and the femtocell 125 may then be determined using the timing offset between the mobile device 115 and the macrocell 105 and the timing offset between the mobile device 115 and the femtocell 125. In some cases, the mobile device 115 may be able to determining a timing offset between the macrocell 105 and the femtocell 125 without necessarily determining a timing offset between the mobile device 115 and the macrocell 105 and a timing offset between the mobile device 115 and the femtocell 125. Timing offset information between the macrocell 105 and the femtocell 125 may be utilized to achieve timing synchronization and tracking at the femtocell 125 with respect to the macrocell 105.

In some embodiments, the mobile device 115 may determine the timing offset between the macrocell 105 and the femtocell 125. The mobile device 115 may then transmit this timing offset between the macrocell 105 and the femtocell 125 directly to the femtocell 125, such as through a WAN link or an out-of-band (OOB) link (e.g., WiFi or bluetooth link). An IP tunnel between the mobile device 115 and the femtocell 125 (e.g., remote IP access or RIPA) may also be utilized in some embodiments. The mobile device 115 may more generally send timing offset information to the femtocell 125 through the macrocell 105, the core network 130, and to a femtocell gateway 140. The femtocell gateway 140 may then forward the timing offset information to the femtocell 125.

In some embodiments, other devices such as the femtocell gateway 140 or the femtocell 125 itself may determine the timing offset between the macrocell 105 and the femtocell 125. In these cases, the mobile device 115 may transmit timing information such as timing offsets to these devices. In one example, the mobile device 115 may transmit both the timing offset between the mobile device 115 and the macrocell 105, and the timing offset between the mobile device 115 and the femtocell 125, to the other device. This other device may then utilize these two timing offsets with respect to the mobile device 115 to determine the timing offset between the macrocell 105 and the femtocell 125. The timing offset between the mobile device 115 and the macrocell 105, and the timing offset between the mobile device 115 and the femtocell 125, sent to the other device may be sent from the mobile device as part of a message that may be referred to as a measurement report message.

Once the femtocell 125 has the timing offset between the macrocell 105 and itself, it can make appropriate corrections in its timing and thus synchronize with its neighboring macrocell 105.

Along with transmitting timing offset information from the mobile device 115 to the femtocell 125, the mobile device 115 may transmit other information, such as identifiers of the macrocell 105 and/or the femtocell 125. For example, the mobile device 115 may send PSC identifiers of the macrocell 105 and/or femtocell 125. This information may be utilized by different devices to determine the identifier of the macrocell 105 and/or femtocell 125.

In some cases, frequency spectrum may be allocated to a particular macrocell 105 or femtocell 125, or for OOB signaling. A macrocell frequency range may be a first frequency channel within a set of frequencies allocated to WWAN communications, and a femtocell frequency range may be a second frequency channel within the set of frequencies allocated to WWAN communications, for example. The macrocell 105 frequency range and the femtocell 125 frequency range may be the same, or different (therefore, there may be an intra-frequency or inter-frequency search for a femtocell 125). Additional macrocell 105 frequency ranges may occupy other frequency channels within the set of frequencies allocated to WWAN communications.

As used herein, “out-of-band,” or “OOB,” includes any type of communications that are out-of-band with respect to the macrocell or femtocell communications network (e.g., WAN). For example, a femtocell 125 and/or the mobile device 115 may be configured to operate using Bluetooth (e.g., class 1, class 1.5, and/or class 2), ZigBee (e.g., according to the IEEE 802.15.4-2003 wireless standard), near field communication (NFC), WiFi, an ultra-wideband (UWB) link, and/or any other useful type of communications out of the macrocell network band.

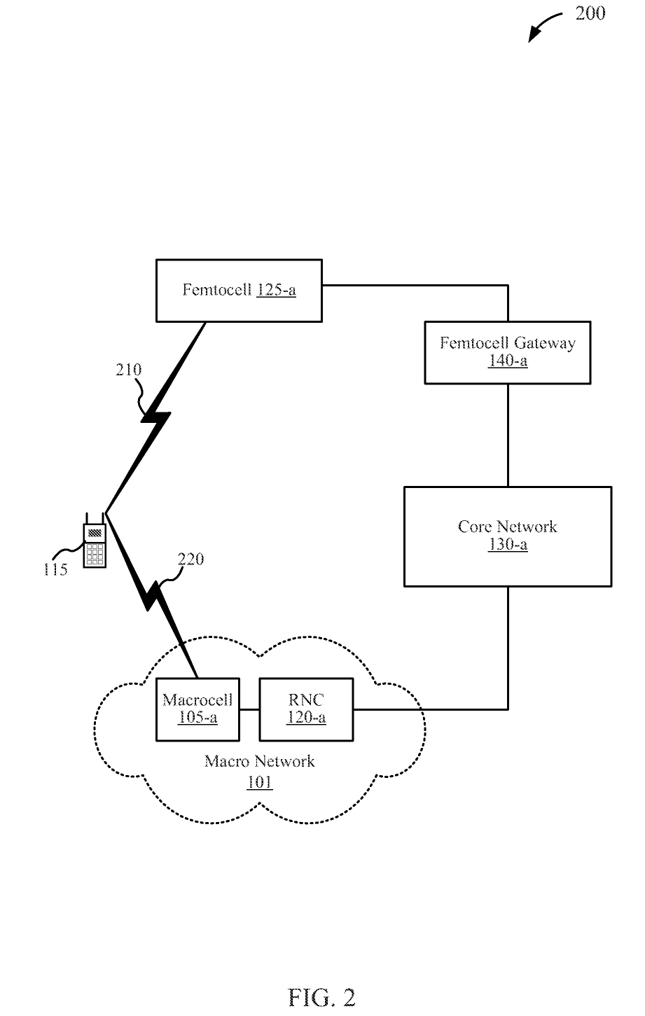

Turning to FIG. 2, a network diagram is shown of a wireless communications system 200 for providing synchronization information regarding a macrocell to a femtocell utilizing a mobile device. Communications system 200 may be an example of the communications system 100 of FIG. 1.

The communications system 200 may include a macro network 101, femtocell 125-a, a core network 130-a, a femtocell gateway 140-a, and one or more mobile devices 115. The core network 130-a may include the femtocell gateway 140-a in some cases (which may be a Home Location Register (HLR), in some cases). The core network 130-a may include a Serving GPRS Support Node (SGSN, not shown) and/or Mobile Switching Center (MSC, not shown). In some embodiments, the femtocell gateway 140-a may be considered outside the core network 130-a. The femtocell gateway 140-a may be in communication with a number of femtocells 125-a (only one femtocell 125-a is shown for clarity), and the core network 130-a may be in communication with multiple macrocell base stations 105-a via one or more macro RNCs 120-a (only one macrocell base station 105 is show for clarity). The femtocell 125-a may be in communication through in-band frequency module (not shown) with the macro network 101 via core network 130-a elements, such that cellular communications may be facilitated through the femtocell 125-a using functionality of the femtocell gateway 140-a and/or core network 130-a.

A mobile device 115 in active communications with the macrocell base station 105-a (over a wireless communications link 220) may approach a coverage area of the femtocell 125-a. The mobile device 115 may move into proximity with the femtocell 125-a. The mobile device 115 may detect the femtocell 125-a over wireless communication link 210. The wireless communications link 210 may be an in-band and/or OOB communications link. In some cases, the mobile device 115 may detect an identifier of the femtocell 125-a, which as a PSC signal of the femtocell 125-a, or other signal, such as an OOB signal, through wireless communication link 210. Upon detecting the femtocell 125-a, the mobile device 115 may be triggered to determine one or more timing offsets that the mobile device 115 may then transmit directly to the femtocell 125-a, or indirectly through the macro network 101, the core network 130-a, and/or the femtocell gateway 140-a. The femtocell 125-a may then utilize the one or more timing offsets or related timing offsets to synchronize with the macrocell base station 105-a.

As described more fully below, embodiments may operate in the context of a system, like the communications system 200 of FIG. 2, to provide synchronization information regarding the macrocell 105-a to the femtocell 125-a utilizing mobile device 115-a. Embodiments may also identify target femtocells 125-a to facilitate hand-ins from the macrocell 105-a to the femtocell 125-a. Some embodiments may involve minimal or no change to legacy macro networks 101 and/or to legacy mobile devices 115. Some embodiments, however, may require some modifications, as discussed in more detail below.

Each of the mobile device 115, the macrocell 105-a, and/or femtocell 125-a may have different identifiers that may be utilized in different embodiments. Some of these identifiers may be utilized in detecting the femtocell 125-a at the mobile device 115. For example, the macrocell 105-a and/or the femtocell 125-a may have different identifiers such as a PSC, pseudo noise (PN) sequence, and/or a physical cell identity (PCI). The mobile device 115 may have an international mobile subscriber identifier (IMSI). The mobile device 115, the macrocell 105-a, and/or the femtocell 125-a may have one more OOB identifiers. Merely by way of example, an OOB identifier may include a unique Bluetooth device address (BD_ADDR) that may be used for paging the other device (e.g., mobile device 115 pages the femtocell 125-a or the femtocell 125-a pages the mobile device 115). This may be utilize by the mobile device 115 in detecting the femtocell 125-a, for example. It is understood that the BD_ADDR of the other device may be known by the paging device. Notably, the same or similar techniques may be used for other types of out-of-band addressing. For example, the devices may know each other's WiFi MAC address, etc.

Wireless communications system 200 may be utilized to provide synchronization information regarding macrocell 105-a to the femtocell 125-a utilizing the mobile device 115. For example, embodiments may include retrieving or otherwise sending the neighboring macrocells' 105 timing information to the femtocell 125. The macrocell 105-a may be referred to as a macro Node B (MNB) in some embodiments; the femtocell 125-a may be referred to as a home Node B (HNB)) in some embodiments. In some cases, measurement report messages (MRMs) from mobile device 115 may be utilized that are associated with the relevant macrocell 105-a and which are looking for candidate macrocells 105 or femtocells 125 for active state handovers. Embodiments may address timing synchronization and tracking for asynchronous and quasi-synchronous wireless networks (e.g., 3GPP variants like UMTS, LTE etc).

In some embodiments, a mobile device 115 associated with a macrocell 105-a may send an MRM to the RNC 120-a when it detects the primary scrambling code (PSC) signal from a neighboring femtocell 125-a. In some cases, the mobile device 115 may also and detect a signal strength between the mobile device 115 and the femtocell 125-a, such as the CPICH E_{c}/I₀, to be above a certain prespecified threshold. This threshold may indicate the proximity of the mobile device 115 to the femtocell 125-a. The MRM may include a tuple ({PSC_{Macrocell}, ΔFN_{Macrocell}}, {PSC_{Femtocell}, ΔFN_{Femtocell}}), where

ΔFN_{Macrocell}=(CFN−SFN_{Macrocell})mod 256,ΔFN_{Femtocell}=(CFN−SFN_{Femtocell})mod 256

are counters that compute the differences between the mobile device 115 and the macrocell 105-a (or femtocell 125-a) frame counters. CFN can represent the connection frame number; SFN can represent the system frame number. These MRMs may be forwarded from the macro RNC 120-a to the core network 130-a to the femtocell gateway 140-a and then to the femtocell 125-a. At the femtocell 125-a, a difference

ΔFN=ΔFN_{Macrocell}−ΔFN_{Femtocell}=(SFN_{Macrocell}−SFN_{Femtocell})mod 256

may be computed. ΔFN may provide the timing offset between the macrocell 105-a and the femtocell 125-a. These offsets are typically measured in terms of “chips” or chip delays, though in some cases, the offset may be determined with respect to an absolute time reference.

In some cases, the measured timing offset may be used for timing correction at the femtocell 125-a where the actual timing offset between the femtocell 125-a and macrocell 105-a may be below a maximum threshold. For example, a frame number difference may be correctly measuring the timing offset where the offset may be less than a frame duration (e.g. 10 ms in UMTS). If the actual timing offset may be greater than 10 ms, then there may be an ambiguity in terms of the frame count. Some embodiments may thus target time tracking and/or fine synchronization. Some embodiments may focus on situations where the femtocell 125-a and the macrocell 105-a may be synchronized within a frame duration. In some embodiments, there may be an initial coarse synchronization step that may achieve synchronization between the reference timing and femtocell timing within the respective acceptable thresholds for the different offsets that may be utilized.

The ΔFN information may be utilized to achieve timing synchronization and tracking at the femtocell 125-a. The femtocell 125-a may have an accurate estimation of the timing offset between its frame timing and the frame timing at the neighboring macrocell 105-a. Once the femtocell 125-a has this information, it can make appropriate corrections in its timing and thus synchronize with its neighboring macrocell 105-a.

In some embodiments, the mobile device 115 can send this tuple to the femtocell 125-a to correct the timing offset. In this form, the femtocell 125-a may compute the ΔFN offset. In another embodiment, the mobile device 115 can itself compute the ΔFN offset and send this offset value along with possibly the PSC_{Macrocell} and/or PSC_{Femtocell} for the timing synchronization to the femtocell 125-a.

In some embodiments, the femtocell gateway 140-a may compute the timing offset, such as ΔFN, which may then be sent to the femtocell 125-a for offset correction and/or synchronization. Note that this forwarding may be triggered by the MRM initiated by the mobile device 115 detecting the femtocell 125-a's PSC. The timing offset, such as the ΔFN offset, computation can be done at the mobile device 115, the femtocell gateway 140-a, and/or the femtocell 125-a, for example.

In another embodiment, the mobile device 115 can transmit timing offset information, such as timing difference between the mobile device 115 and the macrocell 105-a (e.g. ΔFN_{Macrocell}−(CFN−SFN_{Macrocell})mod 256) and/or the femtocell 125-a (e.g. ΔFN_{Femtocell}=(CFN−SFN_{Femtocell})mod 256), or the timing offset information between the macrocell 105-a and femtocell 125-a, such as the ΔFN offset, directly to the femtocell 125-a. There are various ways that the timing offset information may be sent from the mobile device 115 to the femtocell 125-a.

In one embodiment, the mobile device 115 may send the timing offset information, such as the ΔFN offset, directly to the femtocell 125-a over an in-band link such as a WAN link. For example, the mobile device may transmit this timing offset between the macrocell 105-a and the femtocell 125-a directly to the femtocell 125-a over a WAN link between the mobile device 115 and the femtocell 125-a when the mobile device 115 has been handed over from the macrocell 105-a to the femtocell 125-a. In some cases, the mobile device 115 may also send an identifier of the macrocell 105-a, such as the PSC of the macrocell 105-a, along with the timing offset information. In some situations, the mobile device 115 may be assumed to be associated with the macro coverage of the macrocell 105-a and still not associated with the femtocell 125-a.

In another embodiment, the mobile device 115 can send the timing offset information, such as the one or more ΔFN offsets, directly to the femtocell 125-a, over an OOB link (e.g., WiFi or bluetooth link) between the mobile device 115 and the femtocell 125-a. In some cases, the mobile device 115 may also send an identifier of the macrocell 105-a, such as the PSC of the macrocell 105-a, along with the timing offset information. In some cases, using the OOB link may provide the medium for propagating the timing offset information, and not necessarily using the OOB link's clock or synchronization information to achieve femtocell synchronization.

In another embodiment, the mobile device 115 may transmit the timing offset information to the femtocell 125-a through the macrocell 105-a. This may include transmitting the information from the mobile device 115 to the macrocell 105-a over an in-band link between the mobile device 115 and the macrocell 105-a (e.g. WAN link). The information may then pass from the macrocell 105-a through the core network 130-a to the femtocell 125-a. Transmitting the timing offset information from the femtocell 125-a through the macrocell 105-a may also include transmitting the information through an IP tunnel between the mobile device 115 and the femtocell 125-a (e.g., remote IP access or RIPA can be used) and this tunnel can be used to convey the timing offset information, such as the one or more ΔFN offsets, and in some cases an identifier of the macrocell 105-a (e.g. PSC_{Macrocell}) and/or an identifier of the femtocell 125-a (e.g. PSC_{Femtocell}) from the mobile device 115 to the femtocell 125-a. In some cases, the mobile device 115 may be registered to access the femtocell 125-a to utilize these means of transmission.

The ΔFN offset between the femtocell 125-a and the macrocell 105-a may not always be propagated based on the timing offset information sent from the mobile device 115. For example, the macro RNC 120-a and/or macrocell 105-a may periodically send the current timing information of the macrocell 105-a and/or the RNC 120-a (e.g. SFN_{Macrocell}) to the femtocell gateway 140-a so that the femtocell gateway 140-a can update its own repository. This update periodicity can be optimized to balance the tradeoff between signaling overhead, latency and accuracy requirements. The femtocell 125-a can also forward an update of its own current timing information (e.g. SFN_{Femtocell} values) to the femtocell gateway 140-a. The femtocell gateway 140-a may then compute the timing offset, such as ΔFN offset, using these values and updates its repository. Once the offset value exceeds a pre-specified threshold, for example, the femtocell gateway 140-a can request the femtocell 125-a to correct its timing with the current ΔFN offset information. The threshold can be determined based on tradeoff between signaling overhead, accuracy and latency requirements.

Embodiments may thus include differences from other systems. For example, in some embodiments, the mobile devices 115 associated with the macrocell 105-a sends one or more timing offsets, and the offsets may propagates via the macro network to the femtocell 125-a or may be sent directly from the mobile device 115 to the femtocell 125-a. The mobile device 115 may not necessarily be camped on the femtocell 125-a, and may not need any explicit signaling from the femtocell 125-a. In some cases, the mobile device 115 may not have the privilege to camp on specific femtocell 125-a (e.g., femtocells 125-a with closed access). The macro network 101 may share the timing offset information with the femtocell 125-a either periodically or based on triggers (e.g., mobile device 115's MRMs) and may aid the femtocell 125-a in correcting its own timing.

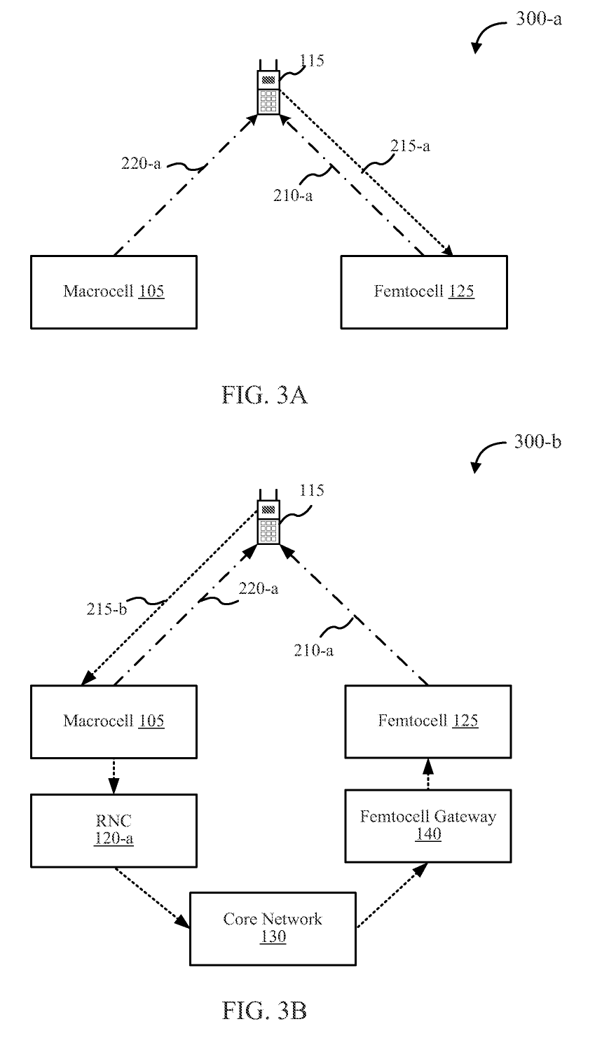

FIG. 3A illustrates portions of a sample communications systems 300-a that may illustrate aspects of communication between the mobile device 115 and the macrocell 105 and/or the femtocell 125 in accordance with various embodiments. Communications system 300-a may represent part of system 100 of FIG. 1 and/or system 200 of FIG. 2. For example, the mobile device 115 may receive timing information from macrocell 105 through wireless communication 220-a and/or timing information from femtocell 125 through wireless communication 210-a. In some cases, the wireless communication 210-a from femtocell 125 to the mobile device 115 may also be utilized as a means for the mobile device to detect the femtocell 125, such as by detecting the PSC signal from the femtocell 125 or other signals, including, but not limited to, OOB signals. Utilizing the received timing information, the mobile device 115 may then directly transmit one or more timing offsets to the femtocell 125 through wireless communication 215-a. The femtocell 125 may then utilize the timing offset information to synchronize with the macrocell 105. The wireless communication 215-a between the mobile device and the femtocell 125 may take a variety of forms including, but not limited, to OOB communication (e.g. Bluetooth) and/or in-band communication (e.g. WAN).

FIG. 3B illustrates portions of a sample communications systems 300-b that may illustrate aspects of communication between the mobile device 115 and the macrocell 105 and/or the femtocell 125, along with other aspects the communications system 300-b, such as the RNC 120-a, the core network 130, and/or the femtocell gateway 140, in accordance with various embodiments. Communications system 300-b may represent part of system 100 of FIG. 1 and/or system 200 of FIG. 2. For example, as discussed above, the mobile device 115 may receive timing information from macrocell 105 through wireless communication 220-a and/or timing information from femtocell 125 through wireless communication 210-a. In some cases, the wireless communication 210-a from femtocell 125 to the mobile device 115 may also be utilized as a means for the mobile device to detect the femtocell 125, such as by detecting the PSC signal from the femtocell or other signals, including, but not limited to, OOB signals. Utilizing the received timing information, the mobile device 115 may then transmit one or more timing offsets to the femtocell 125 indirectly. In this case, the mobile device 115 may first transmit the timing offset information through wireless communication 215-b first to macrocell 105. The macrocell 105 may then transmit the timing offset information to the RNC 120-a, which then transmits the information to the core network 130. The core network may then transmit the timing offset information to the femtocell gateway 140, which then transmits the information to the femtocell 125. The femtocell 125 may then utilize the timing offset information to synchronize with the macrocell 105. The wireless communication 215-b between the mobile device and the macrocell 105 may take a variety of forms including, but not limited, to OOB communication (e.g. Bluetooth) and/or in-band communication (e.g. WAN).

In some cases, elements such as the macrocell 105, the RNC 120-a, the core network 130, the femtocell gateway 140, and/or the femtocell 125 may determine additional timing offset information from the timing offset information they receive. For example, the mobile device 115 may transmit timing offset information that relates to a timing offset between the mobile device 115 and the macrocell 105 along with a timing offset between the mobile device 115 and the femtocell 125. The elements, such as the macrocell 105, the RNC 120-a, the core network 130, the femtocell gateway 140, and/or the femtocell 125 may then utilize these two timing offsets, for example, to determining a timing offset between the macrocell 105 and the femtocell 125 that the femtocell 125 may then utilize to synchronize with the macrocell 105. This timing offset between the macrocell 105 and the femtocell 125 may be transmitted to the femtocell 125 through the communication path shown in FIG. 3B from the element that determines this timing offset. As noted, in some cases, the femtocell 125 itself may determine the timing offset between the macrocell and the femtocell 125.

As can be seen in communications system 300-b, timing offset information may be transmitted through the macrocell 105 before reaching the femtocell 125. In some cases, the timing offset information may be through an IP tunnel.

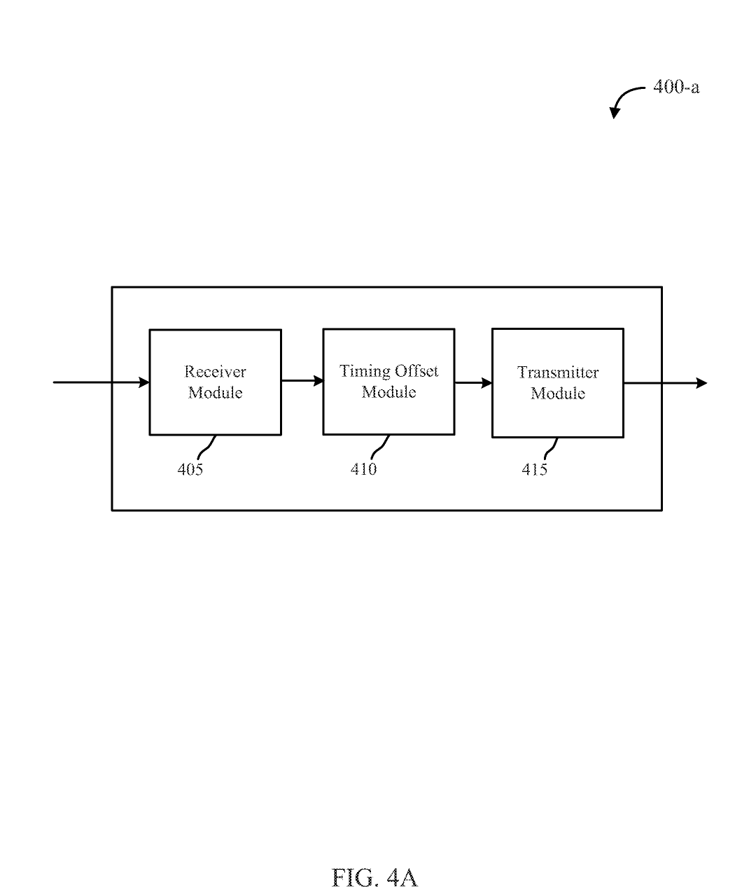

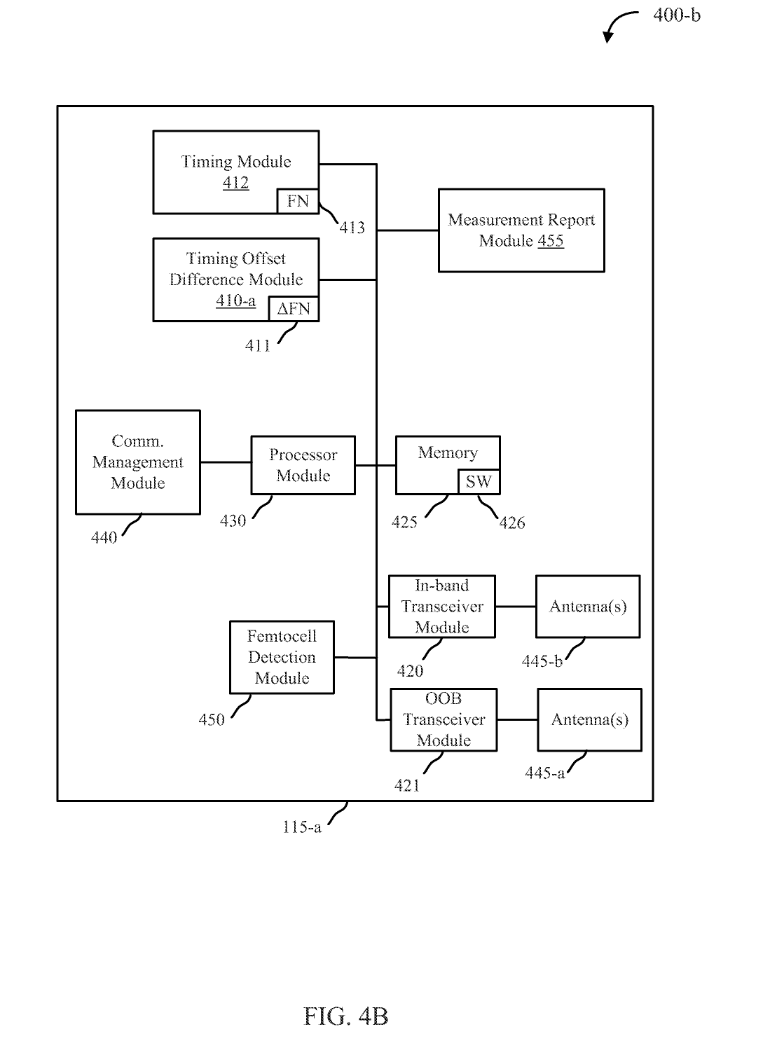

Turning next to FIG. 4A, a block diagram illustrates a device 400-a that includes timing offset functionality. The device 400-a may be the mobile device 115 described with reference to FIG. 1, FIG. 2, FIG. 3A, and/or FIG. 3B, or may be a device integrating the timing offset functionality (e.g., as described with reference to FIGS. 2-3B). The device 400-a may also be a processor. The device 400-a may include a receiver module 405, a timing offset module 410, and/or a transmitter module 415. Each of these components may be in communication with each other.

These components of the device 400-a may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 may receive timing information from different sources, such as macrocells 105 and/or femtocells 125 as shown in FIGS. 1-3B. The timing offset module 410 may utilize the received timing information to determine different timing offsets. For example, the timing offset module 410 may determine a timing offset between the mobile device 115 and the macrocell 105 and a timing offset between the mobile device 115 and the femtocell 125. In some cases, the timing offset module 410 may determine a timing offset difference, such as the difference between the timing offset between the mobile device 115 and the macrocell 105 and the timing offset between the mobile device 115 and the femtocell 125. This timing offset difference may represent the timing offset between the macrocell 105 and the femtocell 125. The transmitter module 415 may transmit one or more of these determined timing offsets to other components of the mobile device 115, and in some case, to the femtocell 125.

The receiver module 405 may also received information indicating the proximity of the femtocell 125 to the mobile device 400-a. For example, the receiver module 405 may detect the femtocell 125 through receiving the PSC signal of the femtocell 125, though the receiver module 405 may also receive other signals from the femtocell 125, such as OOB signals.

The timing offset module 410 may receive timing information such as frame numbers, including system frame numbers, from devices such as the macrocell 105 and/or the femtocell 125. The timing offset module 410 may also receive and/or otherwise determine information such as a connection frame number. These different frame numbers may be utilized to determining the different timing offsets. The timing offset module 410 may also determining timing offsets utilizing other received information from the femtocell 125 and/or macrocell 105. The timing offset module 410 may receive other timing and/or offset information from which other timing offsets may be determined including, but not limited to, a ΔOTD (offset of observable time difference) between the macrocell 105 and femtocell 125 offsets between pilots or known reference signals (e.g., PN offsets between the marcrocell and femtocell), and/or an offset with respect to macro-assisted GPS timing information.

The transmitter module 415 may transmit the one or more timing offsets to other components and/or devices such as the femtocell 125. In some cases, the transmitter module 415 may format the timing offset information, such as into a measurement report message. In some cases, the transmitter module 415 may transmit timing offset information along with other information, such as identifiers of the macrocell 105 and/or femtocell 125, which may include the PSCs and/or OOB identifiers of these devices. The transmitter module 415 may also format the timing offset information such that it may directly transmitted from a mobile device such as a mobile device 115 to the femtocell 125. The transmitter module 415 may also format the timing offset information such that it may be transmitted through the macrocell 105 to the femtocell 125, such as through an IP tunnel.

As described also above, the femtocell 125 may be configured to communicate with client devices, including the mobile devices 115. FIG. 4B shows a block diagram 400-b of mobile device 115-a that may be an example 115 described with reference to FIG. 1, FIG. 2, FIG. 3A, and/or FIG. 3B. The mobile device 115-a may have any of various configurations, such as personal computers (e.g., laptop computers, net book computers, tablet computers, etc.), cellular telephones, PDAs, digital video recorders (DVRs), internet appliances, gaming consoles, e-readers, etc. For the purpose of clarity, the mobile device 115-a is assumed to be provided in a mobile configuration, having an internal power supply (not shown), such as a small battery, to facilitate mobile operation.

The mobile device 115-a may include antennas 445-a,445-b, an in-band transceiver module 420, an OOB transceiver module 421, memory 425, and a processor module 430, which each may be in communication, directly or indirectly, with each other (e.g., via one or more buses). The transceiver modules 420, 421 may be configured to communicate bi-directionally, via the antennas 445-a,445-b with femtocells 125 and macrocells 105. For example, the in-band transceiver module 420 may be configured to communicate bi-directionally with macrocell base stations 105 of FIG. 1 and/or 2, and/or with the femtocells 125 of FIG. 1, 2, 3A and/or 3B. The OOB transceiver module 421 may be configured to communicate bi-directionally with the femtocell 125 of FIG. 1, 2, 3A and/or 3B. Each transceiver module 420, 421 may include a modem configured to modulate the packets and provide the modulated packets to the antennas 445 for transmission, and to demodulate packets received from the antennas 445. While the mobile device 115-a may include a single antenna, the mobile device 115-a will typically include multiple antennas 445 for multiple links.

As generally referenced above, the OOB transceiver module 421 may be configured to communicate with a femtocell 125 over one or more OOB communication links as described in more detail below. The OOB transceiver module 421 at the mobile device 115-a may include a Bluetooth transceiver for example.

The memory 425 may include random access memory (RAM) and read-only memory (ROM). The memory 425 may store computer-readable, computer-executable software code 426 containing instructions that are configured to, when executed, cause the processor module 430 to perform various functions described herein (e.g., call processing, database management, message routing, etc.). Alternatively, the software 426 may not be directly executable by the processor module 430 but be configured to cause the computer (e.g., when compiled and executed) to perform functions described herein.

The processor module 430 may include an intelligent hardware device, e.g., a central processing unit (CPU) such as those made by Intel® Corporation or AMD®, a microcontroller, an application specific integrated circuit (ASIC), etc. The processor module 425 may include a speech encoder (not shown) configured to receive audio via a microphone, convert the audio into packets (e.g., 30 ms in length) representative of the received audio, provide the audio packets to the in-band transceiver module 420, and provide indications of whether a user is speaking. Alternatively, an encoder may only provide packets to the in-band transceiver module 420, with the provision or withholding/suppression of the packet itself providing the indication of whether a user is speaking.

According to the architecture of FIG. 4B, the mobile device 115-a further includes a communications management module 440. The communications management module 440 may manage communications with a macrocell 105, femtocell 125, other mobile devices 115 (e.g., acting as a master of a secondary piconet), etc. By way of example, the communications management module 440 may be a component of the mobile device 115-a in communication with some or all of the other components of the mobile device 115-a via a bus. Alternatively, functionality of the communications management module 440 may be implemented as a component of a transceiver module 420, 421, as a computer program product, and/or as one or more controller elements of the processor module 430.

Some components of the mobile device 115-a may, individually or collectively, be implemented, in whole or in part, with instructions embodied in a memory, formatted to be executed by one or more general or application-specific processors. They may also be implemented with one or more application specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

In many cases, it may be desirable to support active hand-in from a macrocell (e.g., macrocell base stations 105 of FIG. 1) to the femtocell 125 and/or active hand-out from the femtocell 125 to the macrocell base station 105 using handovers to provide seamless voice and data service to active users (active mobile devices 115). In many cases, it may be desirable to support providing synchronization information to a femtocell 125 regarding a macrocell 105 utilizing the mobile device 115-a.

In some embodiments, the mobile device 115-a may move into proximity with a femtocell 125. The mobile device 115-a and/or the femtocell 125 may detect each others presence in a variety of ways as discussed above. For example, femtocell detection module 450 may be utilized to detect the femtocell 125 near the mobile device 115-a. Signals may be received through antenna 445 and/or transceivers 420, 421 that may then be directed to femtocell detection module 450. The femtocell detection module 450 may detect an identifier of the femtocell 125, for example. In some cases, the identifier may be an OOB identifier of the femtocell and/or other identifiers, such as a PSC, PN sequence, and/or PCI identifier of the femtocell 125.

Having detected a femtocell at the femtocell detection module 450, the mobile device 115-a may be triggered to determine one or more timing offsets with respect to the macrocell 105 and/or femtocell 125. For example, the timing module 412 may receive and/or determining timing information with respect to the femtocell 125 and/or macrocell 105. This may include determining frame numbers utilizing frame number submodule 413. For example, the timing module 412 and/or frame number module 413 may determine a system frame number with respect to the macrocell 105 and/or a system frame number with respect to the femtocell 125. The timing module 412 may also receive and/or determining timing information with respect to the mobile device 115-a itself. For example, the timing module 412 may receive and/or determine connection frame number information with respect to the mobile device 115-a. The timing module 412 may receive other timing and/or offset information from which other timing offsets may be determined including, but not limited to, observable time differences (OTD) with respect to the macrocell 105 and/or the femtocell 125, pilot and/or known reference signals, and/or macro-assisted GPS timing information.

The timing information from the timing module 412 may then be utilized by the timing offset difference module 410-a and/or the frame number difference submodule 411. For example, the timing offset difference module 410-a, frame number difference submodule 411 may determine a timing offset between the mobile device 115-a and the macrocell 105. In some cases, this timing offset difference may be represented as a difference between the connection frame number and the system frame number of the macrocell 105. In some cases, the timing offset difference module 410-a, frame number difference submodule 411 may determine a timing offset between the mobile device 115-a and the femtocell 125. In some cases, this timing offset difference may be represented as a difference between the connection frame number and the system frame number of the femtocell 125. The timing difference offset module 410-a and/or frame number difference submodule 411 may also determine a timing offset difference between the macrocell 105 and the femtocell 125. This may be represented as a difference between the system frame number of the macrocell 105 and the system frame number of the femtocell 125 in some cases.

The timing difference offset module 410-a may also receive other timing and/or offset information from which other timing offsets may be determined including, but not limited to, a ΔOTD (offset of observable time difference) between the macrocell 105 and femtocell 125 offsets between pilots or known reference signals (e.g., PN offsets between the marcrocell and femtocell), and/or an offset with respect to macro-assisted GPS timing information.

The timing offset information generated by the timing offset difference module 410-a and/or frame number difference submodule 411 may be transmitted to the femtocell 125, either directly or indirectly as discussed elsewhere, through transceiver 420 and antenna 445-b and/or transceiver 421 and antenna 445-a. In some cases, the measurement report module 455 may generate a message report message that may include the timing offset information that may be sent to the femtocell 125 and/or other devices. In some cases, the measurement report module 455 may also include identifiers of the macrocell 105 and/or femtocell 125 as part of a measurement report message.

As discussed elsewhere, the timing offset information that the timing offset difference module 410-a and/or frame number difference module 411 determine may be utilized by the femtocell 125 to synchronize with the macrocell 105.

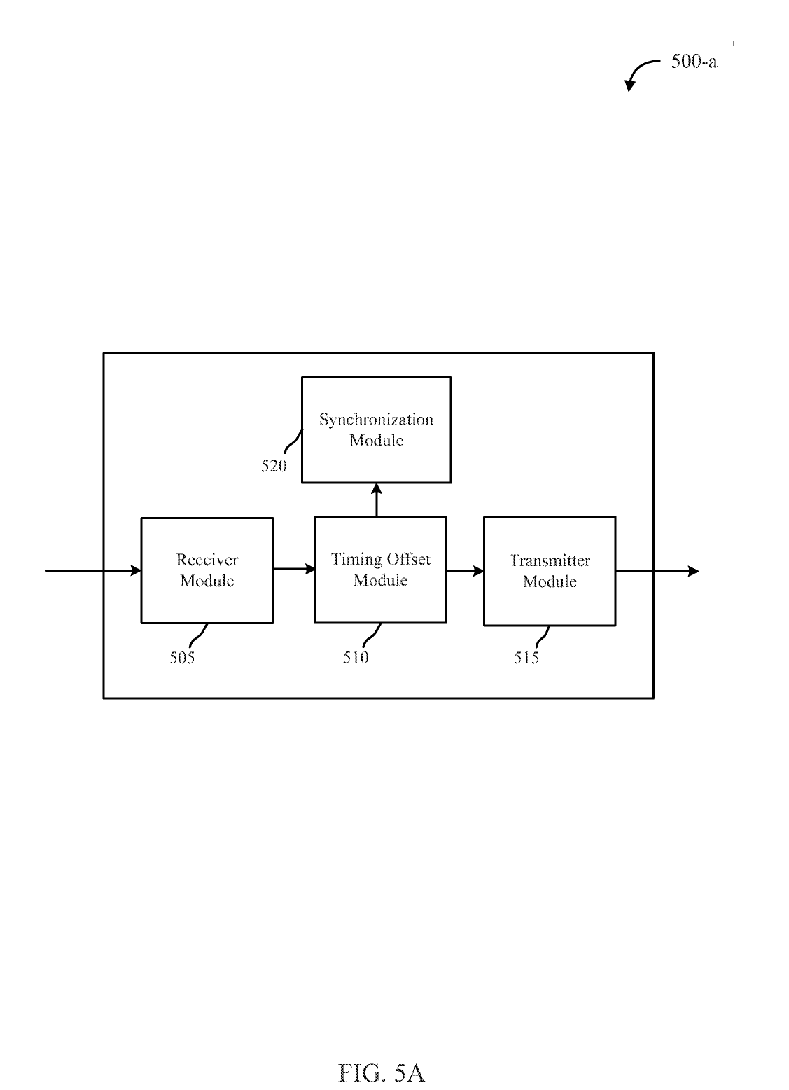

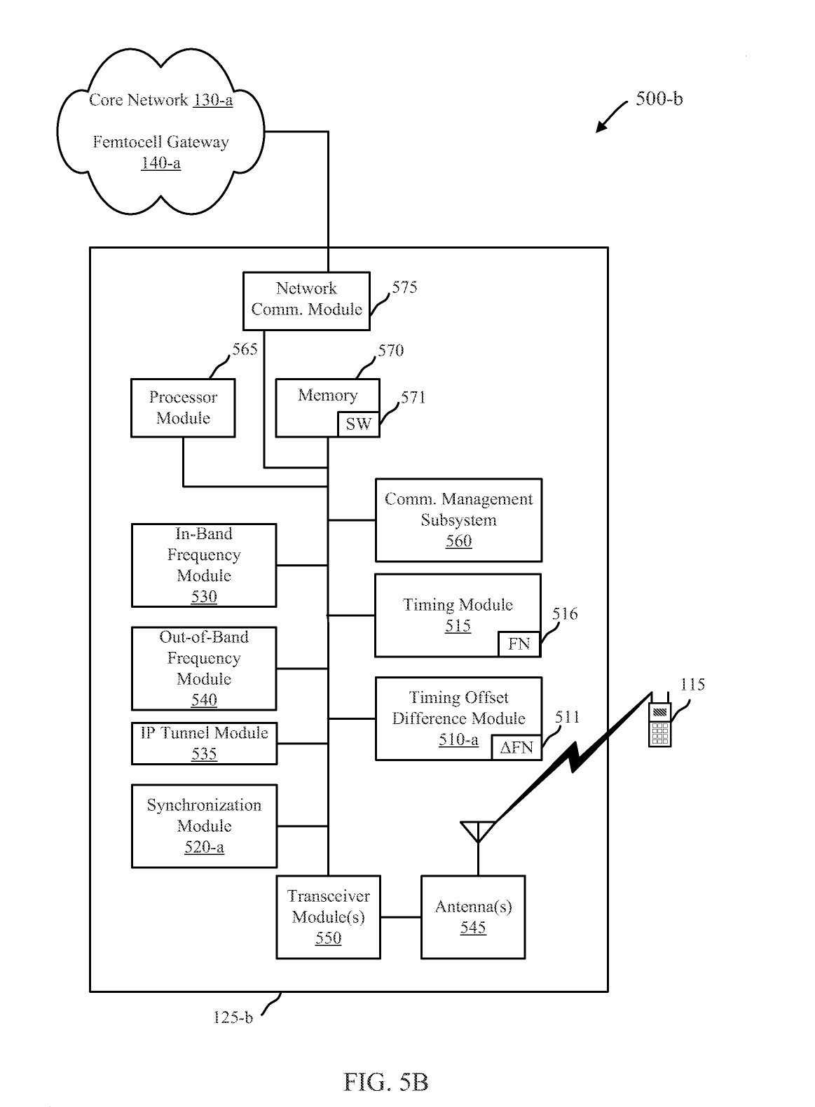

Turning next to FIG. 5A, a block diagram illustrates a device 500-a that includes timing offset and synchronization functionality. The device 500-a may be the femtocell 125 described with reference to FIG. 1, FIG. 2, FIG. 3A, and/or FIG. 3B, or may be a device integrating the timing offset and/or synchronization functionality (e.g., as described with reference to FIGS. 2-4). The device 500-a may also be a processor. The device 500-a may include a receiver module 505, a timing offset module 510, a transmitter module 515, and/or a synchronization module 520. Each of these components may be in communication with each other.

These components of the device 500-a may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive timing offset information from different sources, such as macrocells 105 (through femtocell gateway 140 in some cases) and/or mobile devices 115 as shown in FIGS. 1-3B. The timing offset module 510 may utilize the received timing offset information to determining other timing offset information. For example, the timing offset module 510 may receive a timing offset between the mobile device 115 and the macrocell 105 and a timing offset between the mobile device 115 and the femtocell 125. In some cases, the timing offset module 510 may then determine a timing offset difference, such as the difference between the timing offset between the mobile device 115 and the macrocell 105 and the timing offset between the mobile device 115 and the femtocell 125. In some cases, the timing offset module 510 may receive the timing offset between the macrocell 105 and the femtocell 125. The transmitter module 515 may transmit the timing offset information from the timing offset module 510 to difference devices and/or components, such as other components of the femtocell 125 in some cases. In other cases, the transmitter module 515 may transmit the timing offset information to the synchronization module 520.

The timing offset module 510 may receive timing information such as frame numbers, including system frame numbers, from devices such as the macrocell 105 and/or the femtocell 125. The timing offset module 510 may also receive and/or otherwise determine information such as a connection frame number. These different frame numbers may be utilized to determining the different timing offsets. The timing offset module 510 may also determining timing offsets utilizing other received information from the femtocell 125 and/or macrocell 105. In some embodiments, the timing offset module 510 may other timing and/or offset information from which other timing offsets may be determined including, but not limited to, observable time differences (OTD) with respect to the macrocell 105 and/or the femtocell 125, pilot and/or known reference signals, and/or macro-assisted GPS timing information

The synchronization module 520 may receiving timing offset information from the timing offset module 510 and/or the transmitter module 515. The synchronization module 520 may utilize the timing offset information to synchronize the device 500-a with the macrocell 105, for example. This may result in a femtocell 125 being synchronized with the macrocell 105. In some cases, the synchronization module 520 may utilize the timing offset between the macrocell 105 and the femtocell 125 to perform this synchronization process, though the synchronization module 520 may perform the synchronization in other ways.

FIG. 5B shows a block diagram of a communications system 500-b that may include timing offset and/or synchronization capabilities. This system 500-b may be an example of aspects of the system 100 depicted in FIG. 1 and/or system 200 of FIG. 2, for example. The femtocell 125-b may include an OOB frequency module 540, an in-band frequency module 530, and/or a communications management subsystem 560. The in-band frequency module 530 may be a femto Node B and/or radio network controller, as described with reference to FIG. 1 and/or FIG. 2. The femtocell 125-b also may include antennas 545, a transceiver module 550, memory 570, and a processor module 565, which each may be in communication, directly or indirectly, with each other (e.g., over one or more buses). The transceiver module 550 may be configured to communicate bi-directionally, via the antennas 545, with the mobile device 115. The transceiver module 550 (and/or other components of the femtocell 125-b) may also be configured to communicate bi-directionally with a macro network 101 (e.g., a WWAN). The transceiver module 550 may be configured to communicate with the core network 130-a and/or femtocell gateway 140-a. In cases, the femtocell 125-a may communicate with the core network 130-a and/or femtocell gateway 140-a through network communications module 575.

The memory 570 may include random access memory (RAM) and read-only memory (ROM). The memory 570 may also store computer-readable, computer-executable software code 571 containing instructions that are configured to, when executed, cause the processor module 565 to perform various functions described herein (e.g., call processing, database management, message routing, etc.). Alternatively, the software 571 may not be directly executable by the processor module 565 but be configured to cause the computer, e.g., when compiled and executed, to perform functions described herein.

The processor module 565 may include an intelligent hardware device, e.g., a central processing unit (CPU) such as those made by Intel® Corporation or AMD®, a microcontroller, an application specific integrated circuit (ASIC), etc. The processor module 565 may include a speech encoder (not shown) configured to receive audio via a microphone, convert the audio into packets (e.g., 30 ms in length) representative of the received audio, provide the audio packets to the transceiver module 550, and provide indications of whether a user is speaking. Alternatively, an encoder may only provide packets to the transceiver module 550, with the provision or withholding/suppression of the packet itself providing the indication of whether a user is speaking.

The transceiver module 550 may include a modem configured to modulate the packets and provide the modulated packets to the antennas 545 for transmission, and to demodulate packets received from the antennas 545. While some examples of the femtocell 125-b may include a single antenna 545, the femtocell 125-b preferably includes multiple antennas 545 for multiple links. For example, one or more links may be used to support macro communications with mobile device 115. Also, one or more out-of-band links may be supported by the same antenna 545 or different antennas 545.

Notably, the femtocell 125-b may be configured to provide both in-band frequency module 530 and OOB frequency module 540 functionality. For example, when the mobile device 115 approaches the femtocell coverage area, the mobile device 115's OOB radio may begin searching for the OOB frequency module 540 in order to detect the femtocell 125-b in its proximity. In some cases, the OOB frequency module 540 may page the mobile device 115's OOB radio. Upon discovery, the mobile device 115 may have a high level of confidence that it is in proximity to the femtocell coverage area, and a scan for the in-band frequency module 530 may commence. Similarly, the OOB frequency module 540 may be utilized by the femtocell 125-b to determine that a mobile device 115 is in proximity to the femtocell 125-b.

The scan for the in-band frequency module 530 may be implemented in different ways. For example, due to the OOB frequency module 540 discovery by the mobile device 115's OOB radio, both the mobile device 115 and the femtocell 125-b may be aware of each other's proximity. The mobile device 115 may scan for the in-band frequency module 530. Alternatively, the in-band frequency module 530 may poll for the mobile device 115 (e.g., individually, or as part of a round-robin polling of all registered mobile devices 115), and the mobile device 115 may listen for the poll. When the scan for the in-band frequency module 530 is successful, the mobile device 115 may attach to the in-band frequency module 530. In some cases, the femtocell 125-b may transmit different identifiers of the femtocell 125-b, such as a PSC, a PN sequence, and/or a PCI identifier that the mobile device 115 may be able to detect using an in-band radio. In some cases, the in-band frequency module 530 of the femtocell 125-b may facilitate this process by helping format or otherwise generate the femtocell 125-b identifier.

When the mobile device 115 is in the femtocell coverage area and is linked to the in-band frequency module 530 through a communication link, the mobile device 115 may be in communication with the macro network 101 via the in-band frequency module 530.

Examples of the in-band frequency module 530 may have various configurations of base station or wireless access point equipment. As used herein, the in-band frequency module 530 may be a device that communicates with various terminals (e.g., client devices (mobile device 115, etc.), proximity agent devices, etc.) and may also be referred to as, and include some or all the functionality of, a base station, a Node B, Home Node B, and/or other similar devices. Although referred to herein as the in-band frequency module 530, the concepts herein are applicable to access point configurations other than femtocell configuration (e.g., picocells, microcells, etc.). Examples of the in-band frequency module 530 may utilize communication frequencies and protocols native to a corresponding cellular network (e.g., the macro network 101, or a portion thereof) to facilitate communication within a femtocell coverage area associated with the in-band frequency module 530 (e.g., to provide improved coverage of an area, to provide increased capacity, to provide increased bandwidth, etc.).

The in-band frequency module 530 may be in communication with other interfaces not explicitly shown in FIG. 5B. For example, the in-band frequency module 530 may be in communication with a native cellular interface as part of the transceiver module 550 (e.g., a specialized transceiver utilizing cellular network communication techniques that may consume relatively large amounts of power in operation) for communicating with various appropriately configured devices, such as the mobile device 115, through a native cellular wireless link (e.g., an “in-band” communication link). Such a communication interface may operate according to various communication standards, including but not limited to wideband code division multiple access (W-CDMA), CDMA2000, global system for mobile telecommunication (GSM), worldwide interoperability for microwave access (WiMax), and wireless LAN (WLAN). Also or alternatively, the in-band frequency module 530 may be in communication with one or more backend network interfaces as part of the transceiver module 550 (e.g., a backhaul interface providing communication via the Internet, a packet switched network, a switched network, a radio network, a control network, a wired link, and/or the like) for communicating with various devices or other networks.

As described above, the in-band frequency module 530 may further be in communication with one or more OOB interfaces as part of the transceiver module 550 and/or the OOB frequency module 540. For example, the OOB interfaces may include transceivers that consume relatively low amounts of power in operation and/or may cause less interference in the in-band spectrum with respect to the in-band transceivers. Such an OOB interface may be utilized according to embodiments to provide low power wireless communications with respect to various appropriately configured devices, such as an OOB radio of the UE 115. The OOB interface may, for example, provide a Bluetooth link, an ultra-wideband (UWB) link, an IEEE 802.11 (WLAN) link, etc.

OOB devices (e.g., OOB frequency module 540) may simply consume less power than native cellular interface (e.g., for macro WWAN communications) for a given time of operation. In some implementations, OOB interfaces also provide relatively lower bandwidth communications, relatively shorter range communication, and/or consume relatively lower power in comparison to the macro communications interfaces. There is no limitation that the OOB devices and interfaces be low power, short range, and/or low bandwidth. Devices may use any suitable out-of-band link, whether wireless or otherwise, such as IEEE 802.11, Bluetooth, PEANUT, UWB, ZigBee, an IP tunnel, a wired link, etc. Moreover, devices may utilize virtual OOB links, such as through use of IP based mechanisms over a wireless wide area network (WWAN) link (e.g., IP tunnel over a WWAN link) that acts as a virtual OOB link.

OOB frequency module 540 may provide various types of OOB functionality and may be implemented in various ways. An OOB frequency module 540 may have any of various configurations, such as a stand-alone processor-based system, a processor-based system integrated with a host device (e.g., access point, gateway, router, switch, repeater, hub, concentrator, etc.), etc. For example, the OOB frequency module 540 may include various types of interfaces for facilitating various types of communications. In some embodiments, the OOB frequency module 540 may be referred to as a femto-proxy module.

Some OOB frequency module 540 include one or more OOB interfaces as part of the transceiver module 550 (e.g., a transceiver that may consume relatively low amounts of power in operation and/or may cause less interference than in the in-band spectrum) for communicating with other appropriately configured devices (e.g., a mobile device 115) for providing interference mitigation and/or femtocell selection herein through a wireless link. One example of a suitable communication interface is a Bluetooth-compliant transceiver that uses a time-division duplex (TDD) scheme.

OOB frequency module 540 may also include one or more backend network interfaces as part of the transceiver module 550 (e.g., packet switched network interface, switched network interface, radio network interface, control network interface, a wired link, and/or the like) for communicating with various devices or networks. An OOB frequency module 540 that may be integrated within a host device, such as with in-band frequency module 530, may utilize an internal bus or other such communication interface in the alternative to a backend network interface to provide communications between the OOB frequency module 540 and other devices, if desired. Additionally or alternatively, other interfaces, such as OOB interfaces, native cellular interfaces, etc., may be utilized to provide communication between the OOB frequency module 540 and the in-band frequency module 530 and/or other devices or networks.

Various communications functions (e.g., including those of the in-band frequency module 530, the OOB frequency module 540, the IP tunnel module 535, the synchronization module 520-a, the timing module 515, the frame number submodule 516, the timing offset difference module 510-a, and/or the frame number difference module 511) may be managed using the communications management subsystem 560. For example, the communications management subsystem 560 may at least partially handle communications with the macro (e.g., WWAN) network, one or more OOB networks (e.g., piconets, mobile device 115 OOB radios, other femto-proxies, OOB beacons, etc.), one or more other femtocells (e.g., in-band frequency module 530), mobile devices 115, etc. For example, the communications management subsystem 560 may be a component of the femtocell 125-b in communication with some or all of the other components of the femtocell 125-b via a bus. In some cases, the IP tunnel module 535 may be utilized to manage communication from the mobile device 115 that may be transmitted through the macrocell 105 and received at the femtocell 125-b through an IP tunnel.

Various other architectures are possible other than those illustrated by FIG. 5B. The components of the femtocell 125-b may, individually or collectively, be implemented, in whole or in part, with instructions embodied in a memory, formatted to be executed by one or more general or application-specific processors. They may also be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

Some embodiments of femtocell 125-b may include different configurations. For example, femtocell 125-b may include the OOB frequency module 540 and the in-band frequency module 530, each with its own antenna 545, transceiver module 550, memory 570, and processor module 565. Both transceiver modules 550 may be configured to communicate bi-directionally, via their respective antennas 545, with mobile device 115.

The in-band frequency module 530 may provide a communications link to core network 130-a. However, the in-band frequency module 530 may provide communications functionality via many different types of networks and/or topologies. For example, the in-band frequency module 530 may provide a wireless interface for a cellular telephone network, a cellular data network, a local area network (LAN), a metropolitan area network (MAN), a wide area network (WAN), the public switched telephone network (PSTN), the Internet, etc.

In many cases, it may be desirable to support active hand-in from a macrocell (e.g., macrocell base stations 105 of FIG. 1) to the femtocell 125-b and/or active hand-out from the femtocell 125-b to the macrocell base station 105 using handovers to provide seamless voice and data service to active users (active mobile devices 115). In many cases, it may be desirable to support providing synchronization information to the femtocell 125-b regarding a macrocell utilizing the mobile device 115.

In some embodiments, the mobile device 115 may move into proximity with a femtocell 125-b. The mobile device 115 and/or the femtocell 125-b may detect each others presence in a variety of ways as discussed above. For example, the femtocell 125-b may be transmitting through transceiver module 550 and antenna 545 different identifiers of the femtocell, such as OOB, PSC, PN sequence, and/or PCI identifiers of the femtocell 125-b.

Having detected a femtocell 125-b, the mobile device 115 may be triggered to determining one or more timing offsets with respect to the macrocell 105 and/or femtocell 125-b as discussed above. The mobile device 115 may then transmit one or more timing offsets to the femtocell 125-b.

The femtocell 125-b may receive the one or more timing offsets through antenna 545 and transceiver module 550. The timing module 515 and/or frame number submodule 516 may then utilize the received timing offsets to determine additional offsets, such as a timing offset between the macrocell 105 and the femtocell 125-b. In some cases, the timing offset difference module 510-a, frame number difference submodule 511 may also be utilized to determine a timing offset between the mobile device 115-a and the macrocell 105. In some cases, this timing offset difference may be represented as a difference between the connection frame number and the system frame number of the macrocell 105. In some cases, the timing offset difference module 510-a, frame number difference submodule 511 may determine a timing offset between the mobile device 115 and the femtocell 125-b. In some cases, this timing offset difference may be represented as a difference between the connection frame number and the system frame number of the femtocell 125-b. The timing offset difference module 510-a and/or frame number difference submodule 511 may also determine a timing offset difference between the macrocell 105 and the femtocell 125-b. This may be represented as a difference between the system frame number of the macrocell 105 and the system frame number of the femtocell 125-b in some cases. The timing offset information generated by the timing offset difference module 510-a and/or frame number difference submodule 511 may be sent to the synchronization module 520-a. The synchronization module 520-a may then synchronize the femtocell 125-b with the macrocell 105. The timing offset difference module 510-a may receive other timing and/or offset information from which other timing offsets differencences may be determined including, but not limited to, observable time differences (OTD) with respect to the macrocell 105 and/or the femtocell 125-b, pilot and/or known reference signals, and/or macro-assisted GPS timing information

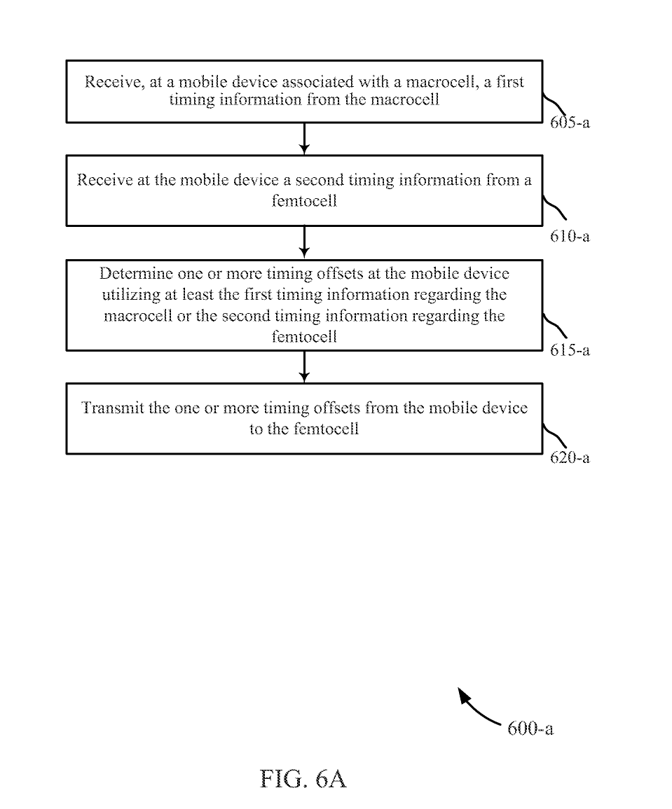

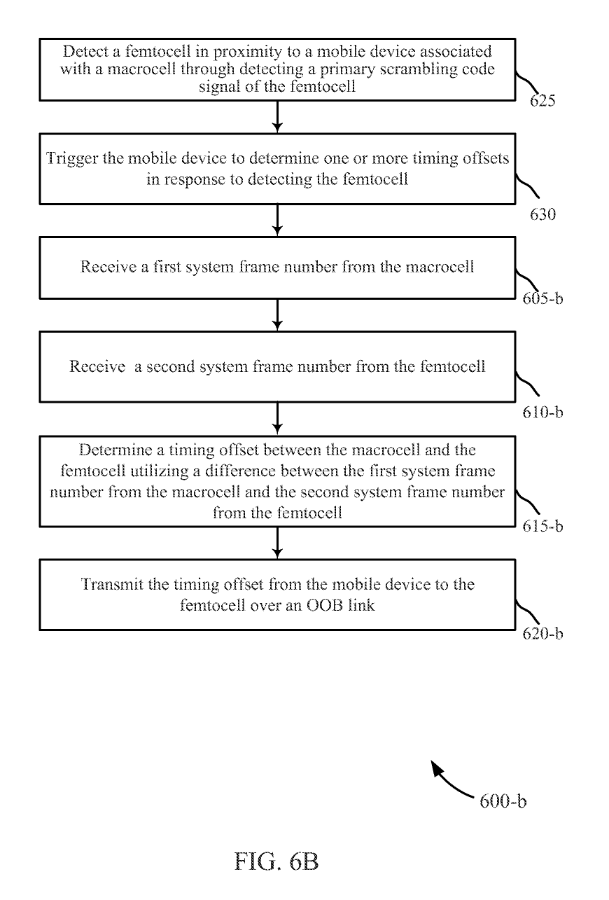

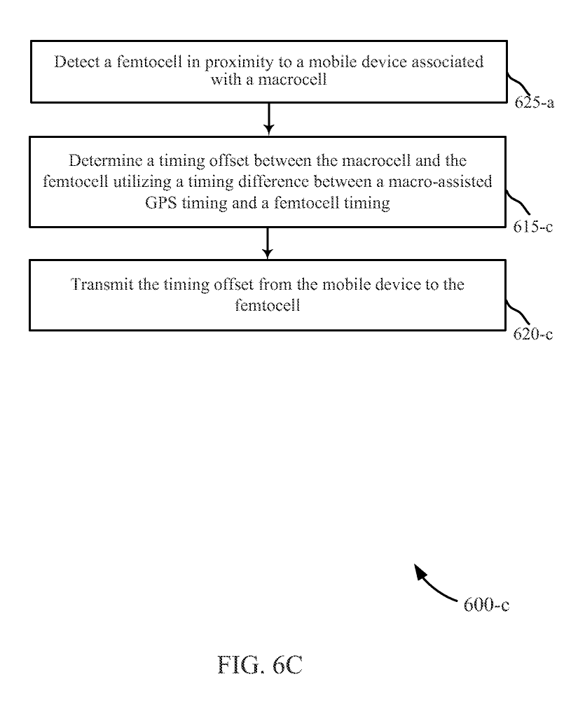

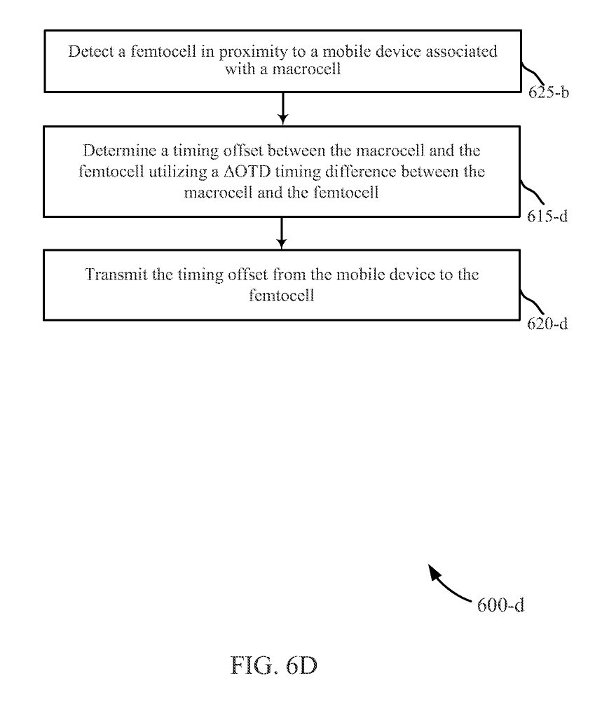

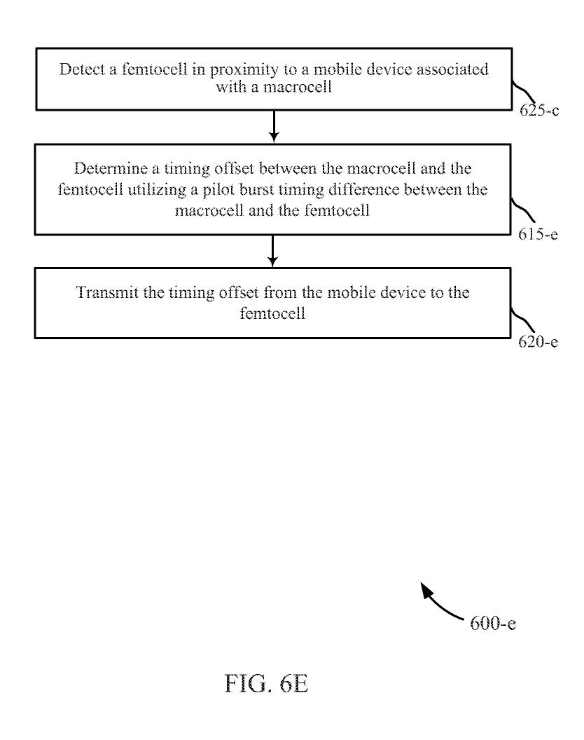

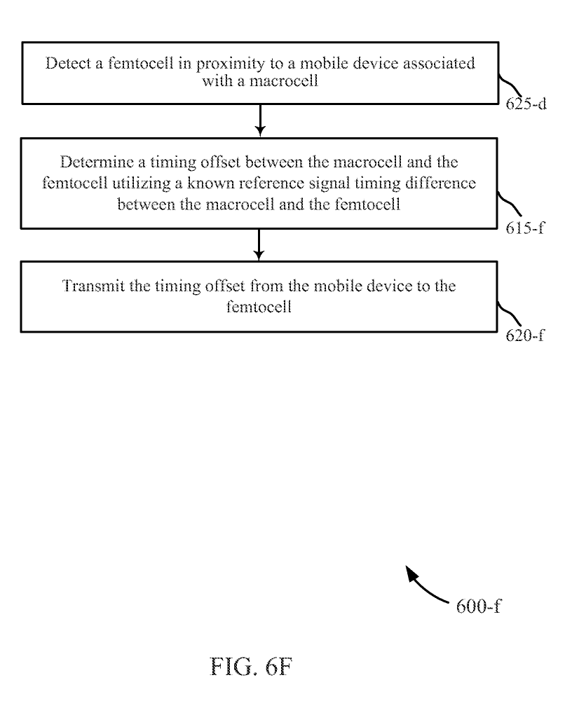

Turning to FIG. 6A, a flowchart illustrating a method 600-a for providing synchronization information in accordance with various embodiments. The method 600—may be performed by a mobile device such as the mobile device 115 of FIG. 1, the mobile device 115 of FIG. 2, the mobile device 115 of FIG. 3A, the mobile device 115 of FIG. 3B, the device 400-a of FIG. 4A, and/or the mobile device 115-a of FIG. 4B, for example.

At block 605-a, a first timing information from a macrocell may be received at a mobile device associated with the macrocell. At block 610-a, a second timing information from a femtocell may be received at the mobile device. At block 615-a, one or more timing offsets may be determined at the mobile device utilizing at least the first timing information regarding the macrocell or the second timing information regarding the femtocell. At block 620-a, the one or more timing offsets from the mobile device may be transmitted to the femtocell.

In some embodiments, the femtocell is detected in proximity to the mobile device. Detecting the femtocell may involve detecting a primary scrambling code (PSC) signal of the femtocell. Detecting the femtocell may involve detecting an out-of-band (OOB) signal of the femtocell. Detecting the femtocell in proximity to the mobile device may trigger the mobile device to determine the one or more timing offsets at the mobile device and to transmit the one or more timing offsets from the mobile device to the femtocell.

In some embodiments, a difference is determined between the first timing information from the macrocell and the second timing information from the femtocell. Determining the difference between the first timing information from the macrocell and the second timing information from the femtocell may include determining a frame number difference between the macrocell and the femtocell. Determining the difference between the first timing information from the macrocell and the second timing information from the femtocell may include determining a frame number difference between the macrocell and the femtocell. Transmitting the one or more timing offsets from the mobile device to the femtocell may include transmitting the frame number difference between the macrocell and the femtocell to the femtocell. Transmitting the one or more timing offsets from the mobile device to the femtocell may include transmitting a first frame number difference between the macrocell and the mobile device and a second frame number difference between the femtocell and the mobile device to the femtocell. In some embodiments, the first time information from the macrocell includes a system frame number of the macrocell and the second time information from the femtocell includes a system frame number of the femtocell. The one or more timing offsets may be transmitted from the mobile device to the femtocell as part of a measurement report message.

In some embodiments, determining the difference between the first timing information from the macrocell and the second timing information from the femtocell may include determining at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell. In some embodiments, transmitting the one or more timing offsets from the mobile device to the femtocell may include transmitting at least the timing difference between the macro-assisted GPS timing and the femtocell timing, the ΔOTD timing difference between the macrocell and the femtocell, the pilot burst timing difference between the macrocell and the femtocell, or the known reference signal timing difference between the macrocell and the femtocell to the femtocell.

In some embodiments, transmitting the one or more timing offsets from the mobile device to the femtocell may include transmitting at least a macro-assisted GPS timing and a femtocell timing, a first ΔOTD timing difference between the macrocell and the mobile device and a second ΔOTD timing difference between the femtocell and the mobile device, a first pilot burst timing difference between the macrocell and the mobile device and a second pilot burst timing difference between the femtocell and the mobile device, or a first known reference signal timing difference between the macrocell and the mobile device and a second known reference signal timing difference between the femtocell and the mobile device. In some embodiments, the first time information from the macrocell may include at least a ΔOTD timing from the macrocell, a pilot burst timing from the macrocell, or a known reference signal timing from the macrocell and the second time information from the femtocell comprises at least at least a ΔOTD timing from the femtocell, a pilot burst timing from the femtocell, or a known reference signal timing from the femtocell.

Transmitting the one or more timing offsets from the mobile device to the femtocell may include transmitting the one or more timing offsets from the mobile device to the femtocell over an out-of-band (OOB) link. Transmitting the one or more timing offsets from the mobile device to the femtocell may include transmitting the one or more timing offsets from the mobile device to the femtocell over an in-band link. In some embodiments, the in-band link may be between the mobile device and the macrocell. In some embodiments, the in-band-link may be between the mobile device and the femtocell, such as when the mobile device has been handed over to the femtocell. Transmitting the one or more timing offsets from the mobile device to the femtocell may include transmitting the one or more timing offsets from the mobile device through the macrocell to the femtocell. Transmitting the one or more timing offsets from the mobile device through the macrocell to the femtocell may include transmitting the one or more timing offsets from the mobile device to the femtocell through an IP tunnel. Transmitting the one or more timing offsets from the mobile device through the macrocell to the femtocell may include transmitting the one or more timing offsets from the mobile device to the femtocell through a core network.

In some embodiments, the macrocell, the core network, a femtocell gateway, or the femtocell may determine for the femtocell a difference between the first timing information from the macrocell and the second timing information from the femtocell. This determined difference may be transmitted to the femtocell.

Turning to FIG. 6B, a flowchart illustrating a method 600-b for providing synchronization information in accordance with various embodiments. The method 600-b may be performed by a mobile device such as the mobile device 115 of FIG. 1, the mobile device 115 of FIG. 2, the mobile device 115 of FIG. 3A, the mobile device 115 of FIG. 3B, the device 400-a of FIG. 4A, and/or the mobile device 115-a of FIG. 4B, for example. The method 600-b may be an example of the method 600-a of FIG. 6A.

At block 625, a femtocell may be detected in proximity to a mobile device associated with a macrocell through detecting a primary scrambling code signal of the femtocell. In some embodiments, the mobile device may detect the femtocell through an out-of-band (OOB) signal. At block 630, the mobile device may be triggered to determine one or more timing offsets in response to detecting the femtocell. At block 605-b, a first system frame number may be received from the macrocell. At block 610-b, a second system frame number may be received from the femtocell. At block 615-b, a timing offset between the macrocell and the femtocell may be determined utilizing a difference between the first system frame number from the macrocell and the second system frame number from the femtocell. At block 620-b, the timing offset may be transmitted from the mobile device to the femtocell over an OOB link.

Turning to FIG. 6C, a flowchart illustrating a method 600-c for providing synchronization information in accordance with various embodiments. The method 600-c may be performed by a mobile device such as the mobile device 115 of FIG. 1, the mobile device 115 of FIG. 2, the mobile device 115 of FIG. 3A, the mobile device 115 of FIG. 3B, the device 400-a of FIG. 4A, and/or the mobile device 115-a of FIG. 4B, for example. The method 600-c may be an example of the method 600-a of FIG. 6A.

At block 625-a, a femtocell may be detected in proximity to a mobile device associated with a macrocell. At block 615-c, a timing offset between the macrocell and the femtocell may be determined utilizing a timing difference between a macro-assisted GPS timing and a femtocell timing. At block 620-c, the timing offset may be transmitted from the mobile device to the femtocell.

Turning to FIG. 6D, a flowchart illustrating a method 600-d for providing synchronization information in accordance with various embodiments. The method 600-d may be performed by a mobile device such as the mobile device 115 of FIG. 1, the mobile device 115 of FIG. 2, the mobile device 115 of FIG. 3A, the mobile device 115 of FIG. 3B, the device 400-a of FIG. 4A, and/or the mobile device 115-a of FIG. 4B, for example. The method 600-d may be an example of the method 600-a of FIG. 6A.

At block 625-b, a femtocell may be detected in proximity to a mobile device associated with a macrocell. At block 615-d, a timing offset between the macrocell and the femtocell may be determined utilizing a ΔOTD timing difference between the macrocell and the femtocell. At block 620-d, the timing offset may be transmitted from the mobile device to the femtocell.

Turning to FIG. 6E, a flowchart illustrating a method 600-e for providing synchronization information in accordance with various embodiments. The method 600-e may be performed by a mobile device such as the mobile device 115 of FIG. 1, the mobile device 115 of FIG. 2, the mobile device 115 of FIG. 3A, the mobile device 115 of FIG. 3B, the device 400-a of FIG. 4A, and/or the mobile device 115-a of FIG. 4B, for example. The method 600-e may be an example of the method 600-a of FIG. 6A.

At block 625-c, a femtocell may be detected in proximity to a mobile device associated with a macrocell. At block 615-e, a timing offset between the macrocell and the femtocell may be determined utilizing a pilot burst timing difference between the macrocell and the femtocell. At block 620-e, the timing offset may be transmitted from the mobile device to the femtocell.

Turning to FIG. 6F, a flowchart illustrating a method 600-f for providing synchronization information in accordance with various embodiments. The method 600-f may be performed by a mobile device such as the mobile device 115 of FIG. 1, the mobile device 115 of FIG. 2, the mobile device 115 of FIG. 3A, the mobile device 115 of FIG. 3B, the device 400-a of FIG. 4A, and/or the mobile device 115-a of FIG. 4B, for example. The method 600-f may be an example of the method 600-a of FIG. 6A.

At block 625-d, a femtocell may be detected in proximity to a mobile device associated with a macrocell. At block 615-f, a timing offset between the macrocell and the femtocell may be determined utilizing a known reference signal timing difference between the macrocell and the femtocell. At block 620-f, the timing offset may be transmitted from the mobile device to the femtocell.

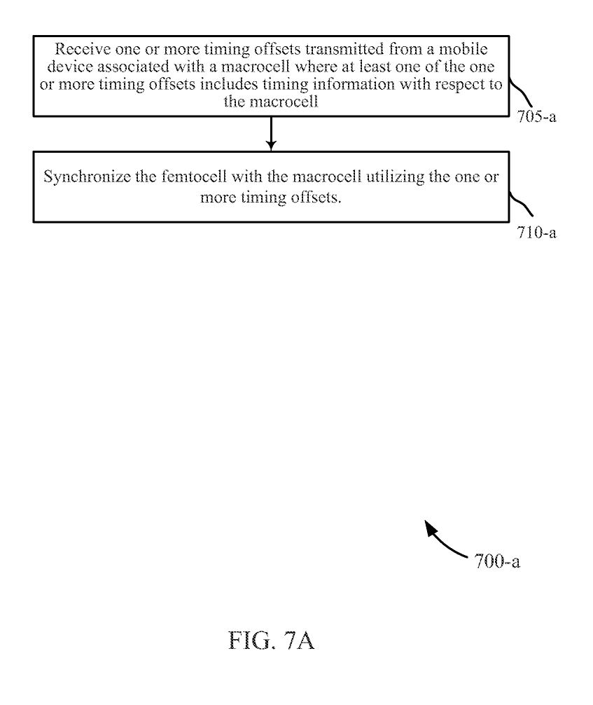

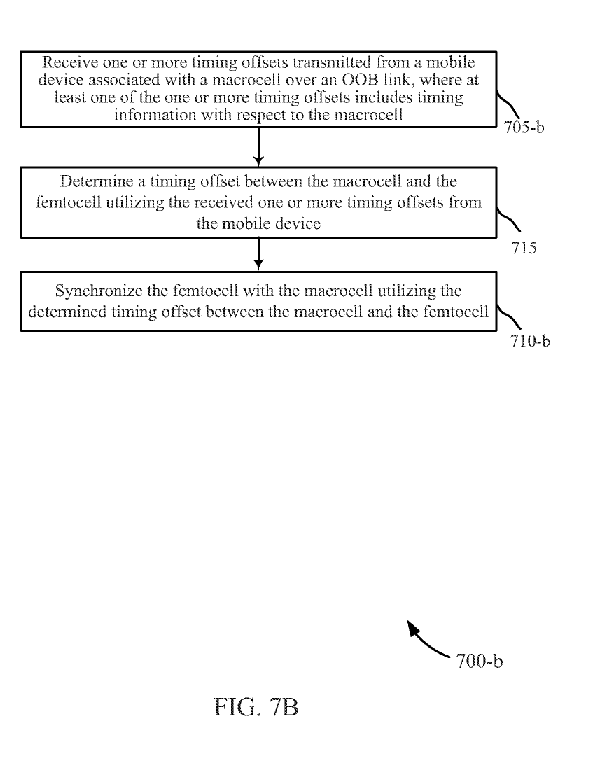

Turning to FIG. 7A, a flowchart illustrating a method 700-a for synchronizing a femtocell with a macrocell utilizing a mobile device in accordance with various embodiments. The method 700-a may be performed by a femtocell such as the femtocell 125 of FIG. 1, the femtocell 125-a of FIG. 2, the femtocell 125 of FIG. 3A, the femtocell 125 of FIG. 3B, the device 500-a of FIG. 5A, and/or the femtocell 125-b of FIG. 5B, for example.

At block 705-a, one or more timing offsets transmitted from the mobile device associated with the macrocell may be received at the femtocell. At least one of the one or more timing offsets may include timing information with respect to the macrocell. At block 710-a, the femtocell may be synchronized with the macrocell utilizing the one or more timing offsets.

A difference between a first timing information of the macrocell and a second timing information of the femtocell may be further determined at the femtocell utilizing the one or more received timing offsets. The determined difference between the first time information of the macrocell and the second time of the femtocell may include a frame number difference between a system frame number of the macrocell and a system frame number of the femtocell. The one or more timing offsets may be received from the mobile device as part of a measurement report message. In some embodiments, determined difference between the first time information of the macrocell and the second time of the femtocell may include at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

Receiving, at the femtocell, the one or more timing offsets transmitted from the mobile device may include receiving a difference between a first timing information of the macrocell and the second timing information of the femtocell. The received difference between the first timing information of the macrocell and the second time of the femtocell may include a frame number difference between the macrocell and the femtocell. In some embodiments, the received difference between the first timing information of the macrocell and the second time of the femtocell may include at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

In some embodiments, the mobile device, the macrocell, a core network, or a femtocell gateway may determine for the femtocell the difference between the first timing information from the macrocell and the second timing information from the femtocell.

Receiving, at the femtocell, the one or more timing offsets transmitted from the mobile device may include receiving the one or more timing offsets from the mobile device over an out-of-band (OOB) link between the mobile device and the femtocell. Receiving, at the femtocell, the one or more timing offsets transmitted from the mobile device may include receiving the one or more timing offsets from the mobile device over an in-band link between the mobile device and the femtocell. Receiving, at the femtocell, the one or more timing offsets transmitted from the mobile device may include receiving the one or more timing offsets from the mobile device through the macrocell. Receiving, at the femtocell, the one or more timing offsets through the macrocell may include receiving the one or more timing offsets from the mobile device through an IP tunnel between the mobile device and the femtocell. Receiving, at the femtocell, the one or more timing offsets through the macrocell may include receiving the one or more timing offsets from the mobile device through a core network.

Turning to FIG. 7B, a flowchart illustrating a method 700-b for synchronizing a femtocell with a macrocell utilizing a mobile device in accordance with various embodiments. The method 700-b may be performed by a femtocell such as the femtocell 125 of FIG. 1, the femtocell 125-a of FIG. 2, the femtocell 125 of FIG. 3A, the femtocell 125 of FIG. 3B, the device 500-a of FIG. 5A, and/or the femtocell 125-b of FIG. 5B, for example. The method 700-b may be an example of the method 700-a of FIG. 7A.

At block 705-b, one or more timing offsets transmitted from the mobile device associated with the macrocell over an OOB link may be received. At least one of the one or more timing offsets may include timing information with respect to a macrocell. At block 715, a timing offset between the macrocell and the femtocell may be determined utilizing the received one or more timing offsets from the mobile device. At block 710-b, the femtocell may synchronize with the macrocell utilizing the determined timing offset between the macrocell and the femtocell.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

1. A method of providing synchronization information, the method comprising:
receiving, at a mobile device camped on a macrocell, a first timing information from the macrocell;
receiving at the mobile device camped on the macrocell, a second timing information from a candidate femtocell for handover from the macrocell;
determining one or more timing offsets at the mobile device utilizing at least the first timing information regarding the macrocell or the second timing information regarding the femtocell; and
transmitting the one or more timing offsets from the mobile device to the femtocell to facilitate handover from the macrocell to the femtocell.

2. The method of claim 1, wherein determining the one or more timing offsets comprises:
determining a difference between the first timing information from the macrocell and the second timing information from the femtocell.

3. The method of claim 1, further comprising:
detecting, at the mobile device, the femtocell in proximity to the mobile device.

4. The method of claim 3, wherein detecting the femtocell in proximity to the mobile device comprises:
detecting, at the mobile device, a primary scrambling code (PSC) signal of the femtocell.

5. The method of claim 3, wherein detecting the femtocell in proximity to the mobile device comprises:
detecting, at the mobile device, an out-of-band (OOB) signal of the femtocell.

6. The method of claim 3, wherein detecting the femtocell in proximity to the mobile device triggers the mobile device to determine the one or more timing offsets at the mobile device and to transmit the one or more timing offsets from the mobile device to the femtocell.

7. The method of claim 1, wherein transmitting the one or more timing offsets from the mobile device to the femtocell comprises:
transmitting the one or more timing offsets from the mobile device to the femtocell over an out-of-band (OOB) link.

8. The method of claim 2, wherein determining the difference between the first timing information from the macrocell and the second timing information from the femtocell comprises:
determining a frame number difference between the macrocell and the femtocell.

9. The method of claim 8, wherein transmitting the one or more timing offsets from the mobile device to the femtocell comprises:
transmitting the frame number difference between the macrocell and the femtocell to the femtocell.

10. The method of claim 2, wherein determining the difference between the first timing information from the macrocell and the second timing information from the femtocell comprises:
determining at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

11. The method of claim 10, wherein transmitting the one or more timing offsets from the mobile device to the femtocell comprises:
transmitting at least the timing difference between the macro-assisted GPS timing and the femtocell timing, the ΔOTD timing difference between the macrocell and the femtocell, the pilot burst timing difference between the macrocell and the femtocell, or the known reference signal timing difference between the macrocell and the femtocell to the femtocell.

12. The method of claim 1, wherein transmitting the one or more timing offsets from the mobile device to the femtocell comprises:
transmitting a first frame number difference between the macrocell and the mobile device and a second frame number difference between the femtocell and the mobile device to the femtocell.

13. The method of claim 1, wherein transmitting the one or more timing offsets from the mobile device to the femtocell comprises:
transmitting at least a macro-assisted GPS timing and a femtocell timing, a first ΔOTD timing difference between the macrocell and the mobile device and a second ΔOTD timing difference between the femtocell and the mobile device, a first pilot burst timing difference between the macrocell and the mobile device and a second pilot burst timing difference between the femtocell and the mobile device, or a first known reference signal timing difference between the macrocell and the mobile device and a second known reference signal timing difference between the femtocell and the mobile device.

14. The method of claim 1, wherein the first time information from the macrocell comprises a system frame number of the macrocell and the second time information from the femtocell comprises a system frame number of the femtocell.

15. The method of claim 1, wherein the first time information from the macrocell comprises at least a ΔOTD timing from the macrocell, a pilot burst timing from the macrocell, or a known reference signal timing from the macrocell and the second time information from the femtocell comprises at least at least a ΔOTD timing from the femtocell, a pilot burst timing from the femtocell, or a known reference signal timing from the femtocell.

16. The method of claim 1, wherein transmitting the one or more timing offsets from the mobile device to the femtocell comprises:
transmitting the one or more timing offsets from the mobile device to the femtocell over an in-band link.

17. The method of claim 1, wherein transmitting the one or more timing offsets from the mobile device to the femtocell comprises:
transmitting the one or more timing offsets from the mobile device through the macrocell to the femtocell.

18. The method of claim 17, wherein transmitting the one or more timing offsets from the mobile device through the macrocell to the femtocell comprises:
transmitting the one or more timing offsets from the mobile device to the femtocell through an IP tunnel.

19. The method of claim 17, wherein transmitting the one or more timing offsets from the mobile device through the macrocell to the femtocell comprises:
transmitting the one or more timing offsets from the mobile device to the femtocell through a core network.

20. A method of providing synchronization information, the method comprising:
receiving, at a mobile device a macrocell, a first timing information from the macrocell;
receiving at the mobile device a second timing information from a femtocell;
determining one or more timing offsets at the mobile device utilizing at least the first timing information regarding the macrocell or the second timing information regarding the femtocell; and
transmitting the one or more timing offsets from the mobile device to the femtocell, wherein transmitting the one or more timing offsets from the mobile device to the femtocell comprises:
transmitting the one or more timing offsets from the mobile device through the macrocell to the femtocell, wherein transmitting the one or more timing offsets from the mobile device through the macrocell to the femtocell comprises:
transmitting the one or more timing offsets from the mobile device to the femtocell through a core network, wherein at least one of the macrocell, the core network, a femtocell gateway, or the femtocell determines for the femtocell a difference between the first timing information from the macrocell and the second timing information from the femtocell.

21. The method of claim 1, wherein the one or more timing offsets are transmitted from the mobile device to the femtocell as part of a measurement report message.

22. A system for providing synchronization information, the system comprising:
a means for receiving, at a mobile device camped on a macrocell, a first timing information from the macrocell;
a means for receiving, at the mobile device camped on the macrocell, a second timing information from a candidate femtocell for handover from the macrocell;
a means for determining one or more timing offsets at the mobile device utilizing at least the first timing information regarding the macrocell or the second timing information regarding the femtocell; and
a means for transmitting the one or more timing offsets from the mobile device to the femtocell to facilitate handover from the macrocell to the femtocell.

23. The system of claim 22, further comprising:
a means for detecting, at the mobile device, the femtocell in proximity to the mobile device.

24. The system of claim 22, further comprising:
a means for transmitting the one or more timing offsets from the mobile device to the femtocell over an out-of-band (OOB) link.

25. A mobile device configured to provide synchronization information, the mobile device comprising:
a receiver configured to receive at least a first timing information from a macrocell that the mobile device is camped on or a second timing information from a candidate femtocell for handover from the macrocell;
a timing offset module configured to determine one or more timing offsets utilizing at least the first timing information from the macrocell or the second timing information from the femtocell; and
a transmitter configured to transmit the one or more timing offsets to the femtocell to facilitate handover from the macrocell to the femtocell.

26. The mobile device of claim 25, wherein the receiver is further configured to:
detect the femtocell in proximity to the mobile device.

27. The mobile device of claim 25, wherein the transmitter is further configured to:
transmit the one or more timing offsets from the mobile device to the femtocell over an out-of-band (OOB) link.

28. The mobile device of claim 25, wherein the transmitter is further configured to:
transmit the one or more timing offsets from the mobile device through the macrocell to the femtocell.

29. The mobile device of claim 25, wherein the timing offset module is further configured to:
determine a frame number difference between the macrocell and the femtocell.

30. The mobile device of claim 25, wherein the timing offset module is further configured to:
determine at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

31. A computer program product for providing synchronization information comprising:
a computer-readable medium comprising:
code for receiving, at a mobile device camped on a macrocell, a first timing information from the macrocell;
code for receiving at the mobile device camped on the macrocell, a second timing information from a candidate femtocell for handover from the macrocell;
code for determining one or more timing offsets at the mobile device utilizing at least the first timing information regarding the macrocell or the second timing information regarding the femtocell; and
code for transmitting the one or more timing offsets from the mobile device to the femtocell to facilitate handover from the macrocell to the femtocell.

32. A method of synchronizing a femtocell with a macrocell, the method comprising:
receiving, at the femtocell, one or more timing offsets transmitted from the mobile device camped on the macrocell, wherein at least one of the one or more timing offsets includes timing information with respect to the macrocell; and
synchronizing the femtocell with the macrocell utilizing the one or more timing offsets to facilitate handover from the macrocell to the femtocell.

33. The method of claim 32, further comprising:
determining, at the femtocell, a difference between a first timing information of the macrocell and a second timing information of the femtocell utilizing the one or more received timing offsets.

34. The method of claim 32, wherein receiving, at the femtocell, the one or more timing offsets transmitted from the mobile device comprises:
receiving the one or more timing offsets from the mobile device over an out-of-band (OOB) link between the mobile device and the femtocell.

35. The method of claim 32, wherein receiving, at the femtocell, the one or more timing offsets transmitted from the mobile device comprises:
receiving the one or more timing offsets from the mobile device over an in-band link between the mobile device and the femtocell.

36. The method of claim 32, wherein receiving, at the femtocell, the one or more timing offsets transmitted from the mobile device comprises:
receiving the one or more timing offsets from the mobile device through the macrocell.

37. The method of claim 36, wherein receiving, at the femtocell, the one or more timing offsets transmitted from the mobile device through the macrocell comprises:
receiving the one or more timing offsets from the mobile device through an IP tunnel between the mobile device and the femtocell.

38. The method of claim 36, wherein receiving, at the femtocell, the one or more timing offsets transmitted from the mobile device through the macrocell comprises:
receiving the one or more timing offsets from the mobile device through a core network.

39. The method of claim 33, wherein the determined difference between the first time information of the macrocell and the second time of the femtocell comprises a frame number difference between a system frame number of the macrocell and a system frame number of the femtocell.

40. The method of claim 33, wherein the determined difference between the first time information of the macrocell and the second time of the femtocell comprises at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

41. The method of claim 32, wherein receiving, at the femtocell, the one or more timing offsets transmitted from the mobile device comprises:
receiving a difference between a first timing information of the macrocell and the second timing information of the femtocell.

42. The method of claim 41, wherein the received difference between the first timing information of the macrocell and the second time of the femtocell comprises a frame number difference between the macrocell and the femtocell.

43. The method of claim 41, wherein the received difference between the first timing information of the macrocell and the second time of the femtocell comprises at least a timing difference between a macro-assisted GPS timing and a femtocell timing, a ΔOTD timing difference between the macrocell and the femtocell, a pilot burst timing difference between the macrocell and the femtocell, or a known reference signal timing difference between the macrocell and the femtocell.

44. The method of claim 32, wherein the one or more timing offsets are received from the mobile device as part of a measurement report message.

45. A system for synchronizing a femtocell with respect to a macrocell utilizing a mobile device, the system comprising:
a means for receiving, at the femtocell, one or more timing offsets transmitted from the mobile device camped on the macrocell, wherein at least one of the one or more timing offsets includes timing information with respect to the macrocell; and
a means for synchronizing the femtocell with the macrocell utilizing the one or more timing offsets to facilitate handover from the macrocell to the femtocell.

46. The system of claim 45, further comprising:
a means for determining, at the femtocell, a difference between a first timing information of the macrocell and a second timing information of the femtocell utilizing the one or more received timing offsets.

47. The system of claim 45, further comprising:
a means for receiving the one or more timing offsets from the mobile device over an out-of-band (OOB) link between the mobile device and the femtocell.

48. A femtocell configured to synchronize with respect to a macrocell utilizing a mobile device comprising:
a receiver configured to receive one or more timing offsets transmitted from the mobile device camped on the macrocell, wherein at least one of the one or more timing offsets includes timing information with respect to the macrocell; and
a synchronization module configured to synchronizing the femtocell with the macrocell utilizing the one or more timing offsets to facilitate handover from the macrocell to the femtocell.

49. The femtocell of claim 48, further comprising:
a timing offset module configured to determine a difference between a first timing information of the macrocell and a second timing information of the femtocell utilizing the one or more received timing offsets.

50. The femtocell of claim 48, wherein the receiver module is further configured to:
receive the one or more timing offsets from the mobile device over an out-of-band (OOB) link between the mobile device and the femtocell.

51. A computer program product for synchronizing a femtocell with respect to a macrocell utilizing a mobile device, the computer program product comprising:
a computer-readable medium comprising:
code for receiving, at the femtocell, one or more timing offsets transmitted from the mobile device camped on the macrocell, wherein at least one of the one or more timing offsets includes timing information with respect to the macrocell; and
code for synchronizing the femtocell with the macrocell utilizing the one or more timing offsets to facilitate handover from the macrocell to the femtocell.
